(19) United States
(12) Patent Application Publication
(10) Pub. No.: US 2003/0236699 A1
(43) Pub. Date: Dec. 25, 2003

(54) System and method of intellectual/immaterial/intangible resource control

(76) Inventor: Anne Krebs, Rungsted Kyst (DK)

Correspondence Address: Ladas & Parry, 26 West 61st Street, New York, NY, 10023, US

(21) Appl. No.: 10/179,457

(22) Filed: Jun. 24, 2002

(51) Int. Cl. G06F 17/60

(52) U.S. Cl. 705/11

(57) ABSTRACT

This invention relates to a method and a system for enabling measurement and control of immaterial/intellectual/intangible resources comprising a processing unit and a database, wherein the database comprises a data structure for a plurality of employees, the data structure comprising a plurality of identification data fields, each identification data field representing and identifying a given employee, at least one knowledge area data field, being associated with knowledge profile data and skill/competence profile data, representing a measure of knowledge and/or experience of an employee, and skill/competence profile data representing a measure of competence of an employee.

By introducing measurable units for intangible/immaterial/intellectual assets it is possible to plan and control these resource in a department, company, holding company, company portfolio for venture capitalists, etc. in a very simple, efficient and structure manner which may be automated to a very high extent.

### FIELD OF THE INVENTION

The invention relates to a system, and a corresponding method, for enabling measurement and control of immaterial/intellectual/intangible resources. More particularly, the invention relates to a system, and a corresponding method, for enabling measurement and control of immaterial/intellectual/intangible resources, the system comprising a processing unit and at least one database in communication connection with the processing unit.

Additionally, the invention relates to a computer readable-medium comprising a program, which may cause a computer to perform the method of the present invention.

### BACKGROUND OF THE INVENTION

Under ‘classic’ economical conditions the competitiveness of a given network, organisation, company, corporate structure, etc. could often be improved by increased economical control, management, etc. of material capital and/or material assets like money, buildings, land, physical objects, goods/commodities in stock, etc.

In an information/knowledge-based economy/society, increased economical control has a relative poor effect. Today, the immaterial, intangible and/or intellectual value of an organisation may very well exceed the material value. Additionally, the immaterial/intellectual/intangible capital, assets, etc., is typically not submitted to any control at all or a very unstructured and/or minimal control at best. One effect of a lack of control of the immaterial/intellectual assets, capital, etc., is that companies do not have the necessary know-how, knowledge, expertise, etc. at the right time. Further effects are that companies cannot typically

plan ahead using knowledge and/or competence/qualifications/skill aspects;

determine which competence/qualifications that are needed, (i.e. should be recruited), that leaves the company, or that already exists within the company;

re-use existing knowledge (in part or fully) at all or very efficiently;

search for and share knowledge within the company; and/or

determine what future qualifications the market demands from them.

The result is that the companies are controlled/managed on the basis of retrospective economical/financial ratios, key figures, budgets, etc., (e.g. last year's financial/fiscal result+a percentile increase for various posts) instead of being controlled/managed on the basis future-oriented immaterial/intellectual ratios, key figures, etc., relating to the company's ability and will to meet strategic goals. This may lead to reduced competitive power/reduced competitiveness of the company.

Additionally, today the share market is not able to provide transparency of the ‘fair’ price/value determination of shares by use of company information that is based exclusively on material capital.

The intuitive determination of a price for a share may initiate a course of events on the share markets that may cause big losses for investors, bankruptcy of companies, etc.

Further, lacking insight into a company may often result in investors being reluctant to invest venture capital into start-up companies/businesses, innovative companies, etc., with ensuing problems to a knowledge-based society/knowledge economy.

Known solutions/tools trying to solve or addressing some of the above-mentioned problems is e.g.:

ERP (Enterprise Resource Planning), CRM (Customer Relationship Management), HRM (Human Resource Management), Balanced Scorecard, and Business Excellence. These concepts all try in one way or another to address the shortcomings of the economical control/management of material capital/assets by managing a company in a certain way according to the specific concept.

However, these concepts have shortcomings as listed in the following.

ERP (Enterprise Resource Planning) is a common designation of systems for planning materiel resources. Some of such systems may include the capacity of working hours, i.e. the number of working hours. However, these kinds of system do typically not address the quality of employee's capacity in these working hours.

CRM (Customer Relationship Management) focuses on the clients of the company and registers and analyses clients purchasing behaviour of the clients, etc.

HRM (Human Resource Management) is systems for the administration of employees that register addresses, age, areas of work, e.g. CVs.

Balanced Scorecard is a global branded system, which also includes other contexts than an economical one. However, Balanced Scorecard does not use or handle qualitative measurements of immaterial values or measurements of the quality of employees' knowledge and competence.

The Business Excellence Model is a system that includes other contexts than an economical/financial context. However, the system does not use, handle or address the quality of employees' knowledge and competence.

However, none of these systems/concepts operates with a qualitative unit of measure. Additionally, none of the systems/concepts involves measuring and daily control of e.g. employees' knowledge, experience, competence, skills, etc., based on qualitative units of measure representing the intangible assets of modern companies today.

### OBJECT AND SUMMARY OF THE INVENTION

It is an object of the present invention to provide a system (and a corresponding method) for enabling measurement and control of immaterial/intellectual/intangible resources within an organization, company, network, etc.

An additional object of the present invention is generally to provide a common basis reference set and language for communication, supply and demand of knowledge and competence that may be used globally.

A further object is to internally in a company to provide an IT-supported process of planning the necessary generation of new knowledge and competence and a process of controlling an effective utilization of strategic knowledge and competence and a future oriented early warning system for the financial operation.

Yet a further object is to avoid the drawbacks listed above.

This is achieved by a system (and a corresponding method) for enabling measurement and control of immaterial/intellectual/intangible resources comprising a processing unit, at least one database in communication connection with the processing unit, wherein said at least one database comprises a data structure for a plurality of employees, said data structure comprising a plurality of identification data fields, each identification data field representing and identifying a given employee, at least one knowledge area data field for each identification data field, each knowledge area data field representing a specific knowledge area and being associated with knowledge profile data and skill/competence profile data, knowledge profile data for each knowledge area data field, the knowledge profile data representing a measure of knowledge and/or experience of an employee represented by said identification data field, and skill/competence profile data for each knowledge area data field, the skill/competence profile data representing a measure of competence of an employee represented by said identification data field.

By introducing measurable units for intangible/immaterial/intellectual assets it is possible to plan and control these resource in a department, company, holding company, company portfolio for venture capitalists, etc. in a very simple, efficient and structure manner which may be automated to a very high extent.

Additionally, a system is provided that enables controls, planning and measurement of immaterial capital in the form of knowledge and competence. The elements of the immaterial capital are knowledge, competence, i.e. the measured ability to personally use knowledge, knowledge consumption and knowledge development during the course of a project, knowledge searches, sharing of knowledge, planning of knowledge, course of project, knowledge upgrading, measurement and recording of knowledge and competence, personal and institutional networks, customer network and relations to the environment for the organization as such.

The system is based on a new structure and weighting of knowledge and competence segments. On the one hand knowledge is broken down into profession and elements of profession from the content of knowledge of public educations, public knowledge parts, and on the other hand for company-specific knowledge identified through local management processes. Each knowledge part produces a number that refers to the level on which the knowledge part is possessed. For each knowledge part a number of competence numbers are produced that refer partly to the type of competence with which the knowledge part can be used, partly to the level on which this competence can be put to use.

By redefining the immaterial resources, measured in a conventional manner e.g. by means of graduation papers, course certificates and grades, whereby —according to the present invention—an immaterial ‘currency’is generated, a structured foundation is measured for bringing about an unprecedented efficient, novel control of immaterial resources. The currency is general and the local adaptation of the currency to the individual company does not preclude a comparison of the immaterial bottom lines of the companies.

By selecting scalable knowledge and competence elements as immaterial ‘currency’, the immaterial capital can be controlled on an individual level, on an organizational sub-level, and on top level through the construction of key figures.

According to one embodiment, said knowledge profile data comprises a first type of numeric value within a predetermined range, the first type of numeric value determining a knowledge and/or experience level of an employee, represented by an associated identification data field, within the knowledge area represented by the associated knowledge area data field.

In this way, a very simple representation of a knowledge and/or experience level is obtained, whereby relatively low complexity data/information in the database is obtained. This may also reduce the processing time and transmission time of such information e.g. in a client/server or ASP (application service provider) system.

According to one embodiment, said skill/competence profile data comprises a first part comprising a creative competence profile data representing what an employee is capable of with a given knowledge and a second part comprising a performance competence profile data representing the degree of possible activity based on a given knowledge for the given employee.

In this way, a very simple representation of a skill/competence level is obtained.

According to one embodiment, said creative competence profile data comprising a second type of numeric value within a predetermined range, the second type of numeric value determining the level of what an employee is capable of with a given knowledge.

In this way, a more diversified measurement of intellectual, immaterial, intangible assets in the form of competence according to the present invention may be obtained, which may be useful or necessary for some implementations.

According to one embodiment, said performance competence profile data comprises a third type of numeric value within a predetermined range, the third type of numeric value determining the level of possible activity based on a given knowledge for the given employee.

In this way, a representation of creative competence is obtained that describes or scores the performance competence in a very simple way.

According to one embodiment, said first type of numeric value is an integer value selected from among the group consisting of 1, 2, 3, 4, 5 and where a numeric value of:

1 represents a knowledge level corresponding to high-school level within the associated specific knowledge area

2 represents a knowledge level corresponding to a bachelor degree level within the associated specific knowledge area

3 represents a knowledge level corresponding to a master degree level within the associated specific knowledge area

4 represents a knowledge level corresponding to a Phd degree level within the associated specific knowledge area, and

5 represents a knowledge level corresponding to Professorship within the associated specific knowledge area.

According to one embodiment, said third type of numeric value is an integer value and said predetermined range is [1 . . . 5] where an integer value of 1 represents a superfluous knowledge level within the associated specific knowledge area and an integer value of 5 represents a profound/deep knowledge level within the associated specific knowledge area.

In this way, a simple alternative representation is obtained.

According to one embodiment, said second type of numeric value is an integer value selected from among the group consisting of 1, 2, 3, 4, 5 and where a numeric value of:

1 represents that an employee is capable, with a given knowledge, of carrying through a dialog superficially and at an agreed time,

2 represents that an employee is capable, with a given knowledge, of reproducing a professional segment and has the ability to understand and interpret the professional segment,

3 represents that an employee is capable, with a given knowledge, of exemplifying and entering the professional segment in relevant contexts and wherein the person has knowledge of complementary professional segments and problems and is able to draw limits relative to profession and level; and/or is single looper in a limited number of areas of profession/subjects,

4 represents that an employee is capable, with a given knowledge, of using knowledge parts, estimating, analyzing, relating relative to defined goals and wherein the person is able to schedule the planning on meta-level, associate, orient himself, estimate and argue, and

5 represents that an employee is capable, with a given knowledge, of personally estimating context, relations, handling many levels of abstraction, complexities, combine in new ways, inter-relate/combine professions/subjects, methods, systems, and/or wherein the person is a double-looper.

According to one embodiment, said third type of numeric value is an integer value selected from among the group consisting of 1, 2, 3, 4, 5 and where a numeric value of:

1 represents that the given employee works most optimally alone in a known environment with known subject-matter,

2 represents that the given employee also works in a team with known subject-matter,

3 represents that the given employee also works both in a team and/or independently with known/unknown subject-matter in a known/unknown environment,

4 represents that the given employee also additionally is able to plan, arrange, engage, enthuse and take responsibility, and

5 represents that the given employee also additionally is able to move globally, win over a large foreign audience in a foreign language and create confidence through media.

According to one embodiment, said system further comprises means for generating a team for a specified project/task/etc., comprising means for inputting/specifying knowledge and/or competence requirements for at least one knowledge area, and means for searching in said database for at least one employee having knowledge profile data and/or competence profile data being a best match with the knowledge and/or competence requirements.

In this way, a team may be automatically generated using the stored intangible values/scores where the team has the necessary skills, experience, knowledge, competence, etc. for the given project, task, etc.

According to one embodiment, said system further comprises means for calculating a measure of difference between said at least one matched result and said inputted/specified knowledge and/or competence requirements.

According to one embodiment, said system further comprises means for generating an intangible key figure for a company by calculating an aggregated knowledge score for a given knowledge area on the basis of a derived average of each of said first type of numeric values representing a knowledge/experience level of an employee, and/or calculating an aggregated competence score for a given knowledge area on the basis of a derived average of each of said second type and/or said third type of numeric values representing a competence level of an employee.

In this way, it is possible to audit knowledge and competence intellectual capital statements and knowledge budgets generated by the system/method which may be standardised and form a comparison basis of different companies. This also enables web-based purchase/sale of knowledge and competence. Additionally, the ability to create valid information on the internal, intangible value of companies and to create partnerships, consortiums and web-based preparations of tender projects over the Internet is enabled, as these intangible key figures may form a common reference and enable a fair price determination of immaterial, intangible and intellectual assets.

According to another aspect of the invention, a system is provided for enabling measurement and control of immaterial/intellectual/intangible resources comprising

a processing unit,

at least one database in communication connection with the processing unit,

wherein said at least one database comprises a data structure, said data structure comprising data representing a measurable unit/level of at least one intangible asset associated with at least one identification data field, the identification data field representing and identifying a given production or business unit, and wherein

said system further comprises means for deriving at least one intangible key figure on the basis of said data structure.

In one embodiment, said intangible asset represents one or more selected from the group of:

knowledge within a given knowledge area,

competence within a given knowledge area, and/or

an immaterial value.

In one embodiment, said given production or business unit is selected from the group of:

a specific company in an venture capitalist portfolio,

a specific employee,

a department in a given company, and

a company belonging to a holding company.

The invention also relates to a method of enabling measurement and control of immaterial/intellectual/intangible resources (and embodiments thereof) that has the same objects and advantages as the system (and embodiments thereof) according to the present invention.

A method is provided that enables measurement and control of immaterial/intellectual/intangible resources comprising storing in at least one database a data structure comprising, for a plurality of employees,

a plurality of identification data fields, each identification data field representing and identifying a given employee,

at least one knowledge area data field for each identification data field, each knowledge area data field representing a specific knowledge area and being associated with knowledge profile data and skill/competence profile data,

knowledge profile data for each knowledge area data field, the knowledge profile data representing a measure of knowledge and/or experience of an employee represented by said identification data field, and

skill/competence profile data for each knowledge area data field, the skill/competence profile data representing a measure of competence of an employee represented by said identification data field.

In one embodiment, said knowledge profile data comprises a first type of numeric value within a predetermined range, the first type of numeric value determining a knowledge and/or experience level of an employee, represented by an associated identification data field, within the knowledge area represented by the associated knowledge area data field.

In one embodiment, said skill/competence profile data comprises a first part comprising a creative competence profile data representing what an employee is capable of with a given knowledge and a second part comprising a performance competence profile data representing the degree of possible activity based on a given knowledge for the given employee.

In one embodiment, said creative competence profile data comprising a second type of numeric value within a predetermined range, the second type of numeric value determining the level of what an employee is capable of with a given knowledge.

In one embodiment, said performance competence profile data comprises a third type of numeric value within a predetermined range, the third type of numeric value determining the level of possible activity based on a given knowledge for the given employee.

In one embodiment, said first type of numeric value is an integer value selected from among the group consisting of 1, 2, 3, 4, 5 and where a numeric value of:

1 represents a knowledge level corresponding to high-school level within the associated specific knowledge area

2 represents a knowledge level corresponding to a bachelor degree level within the associated specific knowledge area

3 represents a knowledge level corresponding to a master degree level within the associated specific knowledge area

4 represents a knowledge level corresponding to a Phd degree level within the associated specific knowledge area, and

5 represents a knowledge level corresponding to Professorship within the associated specific knowledge area.

In one embodiment, said third type of numeric value is an integer value and said predetermined range is [1 . . . 5] where an integer value of 1 represents a superfluous knowledge level within the associated specific knowledge area and an integer value of 5 represents a profound/deep knowledge level within the associated specific knowledge area.

In one embodiment, said second type of numeric value is an integer value selected from among the group consisting of 1, 2, 3, 4, 5 and where a numeric value of:

1 represents that an employee is capable, with a given knowledge, of carrying through a dialog superficially and at an agreed time,

2 represents that an employee is capable, with a given knowledge, of reproducing a professional segment and has the ability to understand and interpret the professional segment,

3 represents that an employee is capable, with a given knowledge, of exemplifying and entering the professional segment in relevant contexts and wherein the person has knowledge of complementary professional segments and problems and is able to draw limits relative to profession and level, and/or is single looper in a limited number of areas of profession/subjects,

4 represents that an employee is capable, with a given knowledge, of using knowledge parts, estimating, analyzing, relating relative to defined goals and wherein the person is able to schedule the planning on meta-level, associate, orient himself, estimate and argue, and

5 represents that an employee is capable, with a given knowledge, of personally estimating context, relations, handling many levels of abstraction, complexities, combine in new ways, inter-relate/combine professions/subjects, methods, systems, and/or wherein the person is a double-looper.

In one embodiment, said third type of numeric value is an integer value selected from among the group consisting of 1, 2, 3, 4, 5 and where a numeric value of:

1 represents that the given employee works most optimally alone in a known environment with known subject-matter,

2 represents that the given employee also works in a team with known subject-matter,

3 represents that the given employee also works both in a team and/or independently with known/unknown subject-matter in a known/unknown environment,

4 represents that the given employee also additionally is able to plan, arrange, engage, enthuse and take responsibility, and

5 represents that the given employee also additionally is able to move globally, win over a large foreign audience in a foreign language and create confidence through media.

In one embodiment, said method comprises the step of generating a team for a specified project/task/etc., said step comprising

inputting/specifying knowledge and/or competence requirements for at least one knowledge area, and

searching in said database for at least one employee having knowledge profile data and/or competence profile data being a best match with the knowledge and/or competence requirements.

In one embodiment, said method further comprises calculating a measure of difference between said at least one matched result and said inputted/specified knowledge and/or competence requirements.

In one embodiment, said method further comprises generating an intangible key figure for a company by

calculating an aggregated knowledge score for a given knowledge area on the basis of a derived average of each of said first type of numeric values representing a knowledge/experience level of an employee, and/or

calculating an aggregated competence score for a given knowledge area on the basis of a derived average of each of said second type and/or said third type of numeric values representing a competence level of an employee.

In one embodiment, a method, is provided, for enabling measurement and control of immaterial/intellectual/intangible resources comprising

a processing unit,

at least one database in communication connection with the processing unit,

wherein said at least one database comprises a data structure, said data structure comprising data representing a measurable unit/level of at least one intangible asset associated with at least one identification data field, the identification data field representing and identifying a given production or business unit, and wherein

said wherein said method comprises deriving at least one intangible key figure on the basis of said data structure.

In one embodiment, said intangible asset represents one or more selected from the group of:

knowledge within a given knowledge area,

competence within a given knowledge area, and/or

an immaterial value.

In one embodiment, said given production or business unit is selected from the group of:

a specific company in an venture capitalist portfolio,

a specific employee,

a department in a given company, and

a company belonging to a holding company.

The method and embodiments thereof have the same advantages as the system and embodiments thereof for the same reasons why they will not be described again.

Further, the invention relates to a computer-readable medium having stored thereon instructions for causing one or more processing units or a computer system to execute the method described above and in the following. A computer-readable medium may e.g. be a CD-ROM, a CD-R, a DVD RAM/ROM, a floppy disk, a hard disk, a smart card, a network accessible via a network connection, a ROM, RAM, and/or Flash memory, etc., or generally any other kind of media that provides a computer system with information regarding how instructions/commands should be executed.

Hereby, when a computer is caused to retrieve electronic information—as a consequence of the contents of a computer-readable medium as described above—the advantages mentioned in connection with the corresponding method according to the invention are achieved.

### BRIEF DESCRIPTION OF THE DRAWINGS

The present invention will now be described more fully with reference to the drawings, in which

FIG. 1a illustrates the concept of the present invention;

FIG. 1b illustrates a schematic graph-representation of a knowledge profile according to the present invention;

FIG. 1c illustrates a knowledge profile for knowledge sub-parts of a given knowledge area;

FIG. 1d illustrates a schematic graph-representation of a first part of a competence/skill profile according to the present invention and of a second part of a competence/skill profile according to the present invention;

FIG. 2a illustrates a schematic representation of one embodiment of a data structure according to the present invention;

FIG. 2b illustrates a schematic representation of an alternative embodiment of a data structure according to the present invention;

FIG. 2c illustrates exemplary values in a part of a data structure according to one embodiment of the present invention;

FIG. 3 illustrates a schematic block diagram of a system according to the present invention;

FIG. 4a illustrates a user interface of the system/method comprising an overview of various knowledge areas;

FIG. 4b illustrates a user interface of the system/method comprising an overview of demand, supply and difference for immaterial/intangible assets;

FIG. 4c illustrates a user interface that may be used in connection with presentation or identification of strategic knowledge;

FIG. 4d illustrates a user/presentation interface used to give an overview over knowledge areas and associated knowledge and competence levels for a given person;

FIG. 4e illustrates a user/presentation interface the information of the interface shown in FIG. 4d and additional information;

FIG. 4f illustrates a user interface useful for finding a person possessing given knowledge;

FIG. 4g illustrates a user interface at a deeper level in category structure/taxonomy also explained in connection with FIG. 4f;

FIG. 4h illustrates a user interface showing a listing of aggregated/total knowledge and competence for a number of knowledge areas and names of employees who posses this capital;

FIG. 5a illustrates a user interface of automatic team generation according to the present invention where required knowledge is selected and potential persons may be determined;

FIG. 5b illustrates another user interface of automatic team generation where the generated team is presented;

FIG. 6a illustrates a knowledge budget according an embodiment of to the present invention;

FIG. 6b illustrates a competence budget according an embodiment of to the present invention;

FIG. 6c illustrates a knowledge account according an embodiment of to the present invention;

FIG. 6d illustrates a competence account according an embodiment of to the present invention;

FIG. 7a illustrates intangible/immaterial/intellectual Key Figures and exemplary values according an embodiment of to the present invention;

FIG. 7b illustrates other examples of intangible/immaterial/intellectual Key Figures according to an embodiment of the present invention.

### DESCRIPTION OF PREFERRED EMBODIMENTS

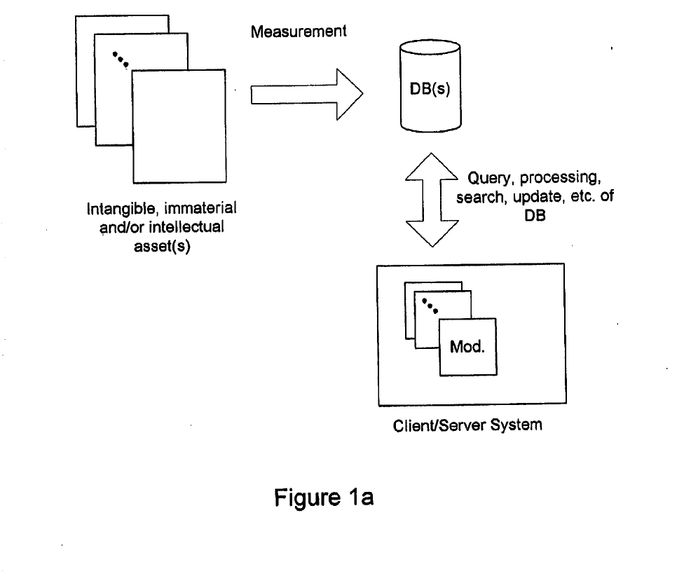

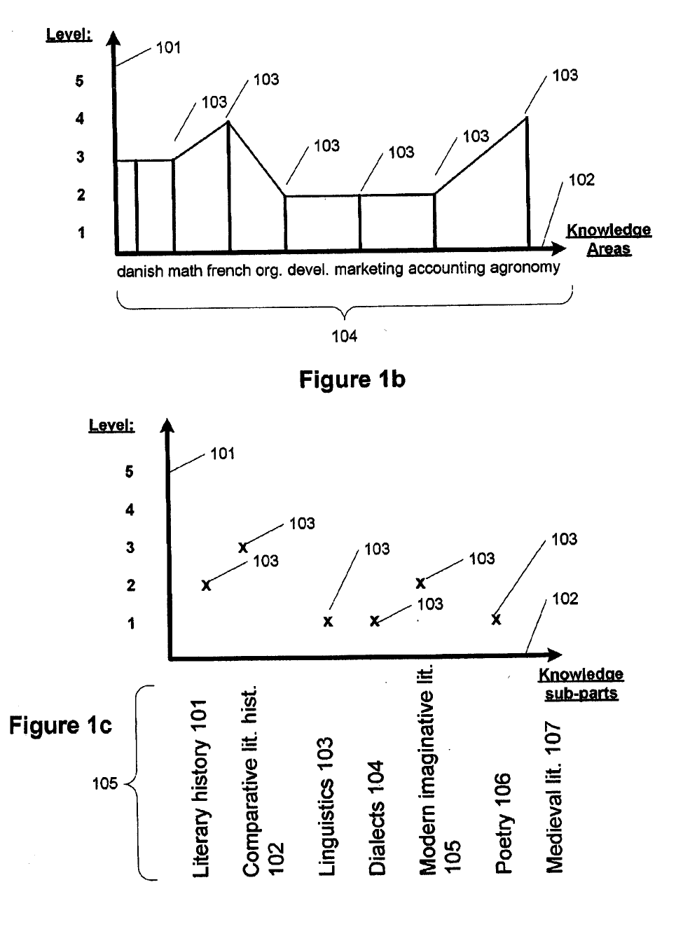

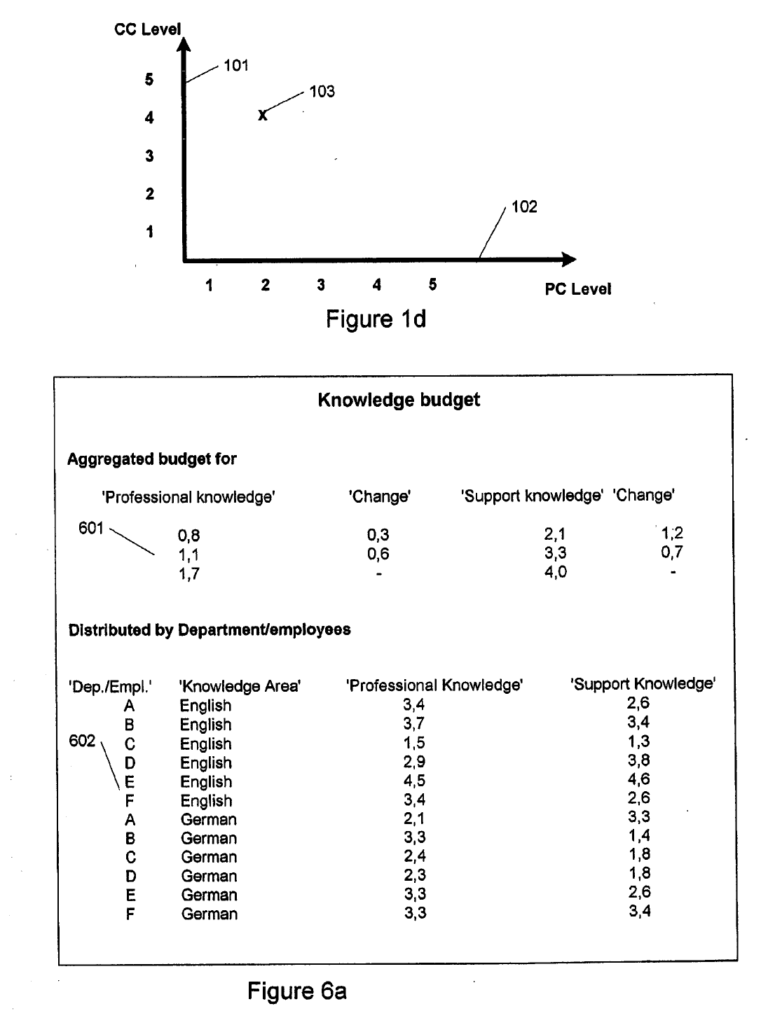

FIG. 1a illustrates the concept of the present invention. Shown a number of intangible, immaterial and/or intellectual assets. A measurement of the assets is obtained initially and stored in one or more databases for later processing, retrieval, change, etc. The intangible, immaterial and/or intellectual assets being measured and how that are measured/quantified may vary from implementation to implementation. As one example (being used in the following) a measurement of a knowledge level, a competence level (e.g. split into a creative competence and a performance competence level) for each knowledge area being possessed by an employee in a company is obtained. The actual measurement and possible levels is also explained in the following. Another example, is e.g. obtaining measurements for a number of companies in order to determine or assess their immaterial, intellectual and/or intangible value. This could e.g. be useful for venture capitalists. A measurement may e.g. be number of patents granted and/or filed this year, number of researchers/developers in the work force in each company, etc. The system/method according to the present invention could then be used to identify and control the values that the measurements represent.

Also shown in the figure, is a client/server system having access to the database. Alternatively, the client/server system may be arranged as an ASP (application service provider) system e.g. using the Internet. The client and/or server preferably comprises a number of functional modules capable of querying, processing, changing, updating, searching, etc. the information stored in the database(s). Preferably, the modules may be run on a different or the same client/server. One module/functionality is e.g. responsible for supporting the process from a potential assignment/idea—aspiring project-ongoing project—to a project bank. The process may e.g. comprise a digital virtual project room where different employees may cooperate, different types of version control, searching of existing information within the company, etc. A project is after completion stored in a project bank where a tracking of the course of events is possible. E.g who participated, what knowledge (expressed according to the present invention) was generated, how many new ideas did it result to pr. year, etc.

Another module may be responsible for transferring clients', customers', etc. goal(s) to the Intangible Standard/the intangible unit of measure according to the present invention thereby creating a list of demand of future strategic knowledge—which is used automatically when employees plans their immaterial budget.

Additionally, it is also possible using the present invention to provide Intellectual Capital Budget and Statements, where Intellectual capital statements/knowledge budgets and/or competence accounts/budgets are generated through the production of intangible key figures, history, tendencies and documented future training. The intellectual capital statements may be published as a supplement to the financial statements of the annual accounts. This will shed light on the dark areas, which currently are the various types of intellectual capital and its status, and make them transparent to investors as both the company's will to and capacity to reach explicit objectives are documented in a credible and pro-active manner.

In one embodiment, the intangible asset ‘Knowledge’ is measured and viewed as a passive asset activated through competence, both Creative Competence and Performance Competence. Competence is the degree of training and education in accordance with educational standards or the nomenclature pertaining to a given country or network. The higher the level of training and education, the higher the score e.g. on a scale from 1-5.

In one embodiment, the intangible asset ‘Experience’ is determined and defined with management as company specific Knowledge in the company starting an implementation process. Thereafter, experience equals Knowledge in the company in question and in registered in the Knowledge Protocol at the same level as Knowledge.

Competence may be registered in accordance with a taxonomy clearly separating individual competence levels into 5 individual steps. The taxonomy describes what the employee is capable of with the knowledge in question—describes the degree of activity based on the knowledge in question—either as regards creativity or as regards performance.

The Intangible Standard/the intangible unit of measure preferably consists of three numbers between 1 and 5 for each part of the knowledge, i.e. a number for the level of the Knowledge/Experience held, a number for the creativity with which the employee may activate the Knowledge in question and finally a number for the performance ability the employee may use to employ the knowledge.

Further it is possible to provide ‘Auditing’ of the intangible assets using the Intangible Standard/the intangible unit of measure. Furthermore, it is a vision to be able to audit knowledge and competence intellectual capital statements and knowledge budgets generated by the system/method—and that such auditing is as credible and consistent as the auditing of financial accounts. This enables web-based purchase/sale of knowledge and competence and enables the creation of valid information on the internal, intangible value of companies and enables the creation of partnerships, consortiums and web-based preparations of tender projects over the Internet.

Additionally, focus of importance to future-oriented management in a knowledge and competence perspective may be obtained.

Additionally, it is also possible to control a project, search for existing knowledge within a company using the Intangible Standard/the intangible unit of measure.

The present invention enables control, planning and measurement of immaterial capital. The elements of the immaterial capital are knowledge, competence, i.e. the measured ability to personally use knowledge, knowledge consumption and knowledge development during the course of a project, knowledge searches, sharing of knowledge, planning of knowledge, course of project, knowledge upgrading, measurement and recording of knowledge and competence, personal and institutional networks, customer network and relations to the environment for the organization as such.

The system is based on a new structure and weighting of knowledge and competence segments. On the one hand knowledge is broken down into profession and elements of profession from the content of knowledge of public educations, public knowledge parts, and on the other hand for company-specific knowledge identified through local management processes. Each knowledge part produces a number that refers to the level on which the knowledge part is possessed. For each knowledge part a number of competence numbers are produced that refer partly to the type of competence with which the knowledge part can be used, partly to the level on which this competence can be put to use.

By redefining the immaterial resources, measured in a conventional manner e.g. by means of graduation papers, course certificates and grades, whereby —according to the present invention—an immaterial ‘currency’ is generated, a structured foundation is measured for bringing about an unprecedented efficient, novel control of immaterial resources. The currency is general and the local adaptation of the currency to the individual company does not preclude a comparison of the immaterial bottom lines of the companies.

By selecting scalable knowledge and competence elements as immaterial ‘currency’, the immaterial capital can be controlled on an individual level, on an organizational sub-level, and on top level through the construction of key figures.

FIG. 1b illustrates a schematic graph-representation of a knowledge profile according to the present invention. The knowledge profile represents the knowledge data for a given employee. Shown are a first axis (102) and a second axis (101). The first axis (102) represents various areas of knowledge (104). Shown in this example is e.g. the knowledge areas: ‘Danish’, ‘Math’, ‘French’, ‘Organizational Development’, ‘Marketing’, ‘Accounting’, ‘Agronomy’. The second axis (101) represents the various levels (103) of knowledge of the given specific knowledge areas (the first axis (104)) possessed by the particular employee.

Preferably, the levels (103) of knowledge are represented by an integer value within the range of form 1 to 5, 1 representing the lowest level while 5 represents the highest level.

In one embodiment, the five levels (1, 2, 3, 4, 5) correspond to:

1 represents a superfluous knowledge level within the associated specific knowledge area and an integer value of 5 represents a profound/deep knowledge level within the associated specific knowledge area. The values in-between (2, 3, 4) correspond to intermediate levels between 1 and 5.

In an alternative embodiment, the five levels (1, 2, 3, 4, 5) corresponds to:

1: Student (or high school degree)

2: Bachelor degree (or similar)

3: Master degree (or similar)

4: Phd, and

5: Professor.

Alternatively, a number (both higher and lower) of levels other than 5 may be used. As yet another alternative, the values may be non-integers, percentages, etc.

In this particular example, the employee in question has a knowledge level of 2 within the knowledge areas Organization, Marketing and Accounting; a knowledge level of 3 within the knowledge areas Danish, Math; and a knowledge level of 4 within the knowledge areas French and Agronomy.

This knowledge profile/the knowledge profile data is preferably obtained for a number of employees and stored in one or more databases for use by the system and method according to the present invention.

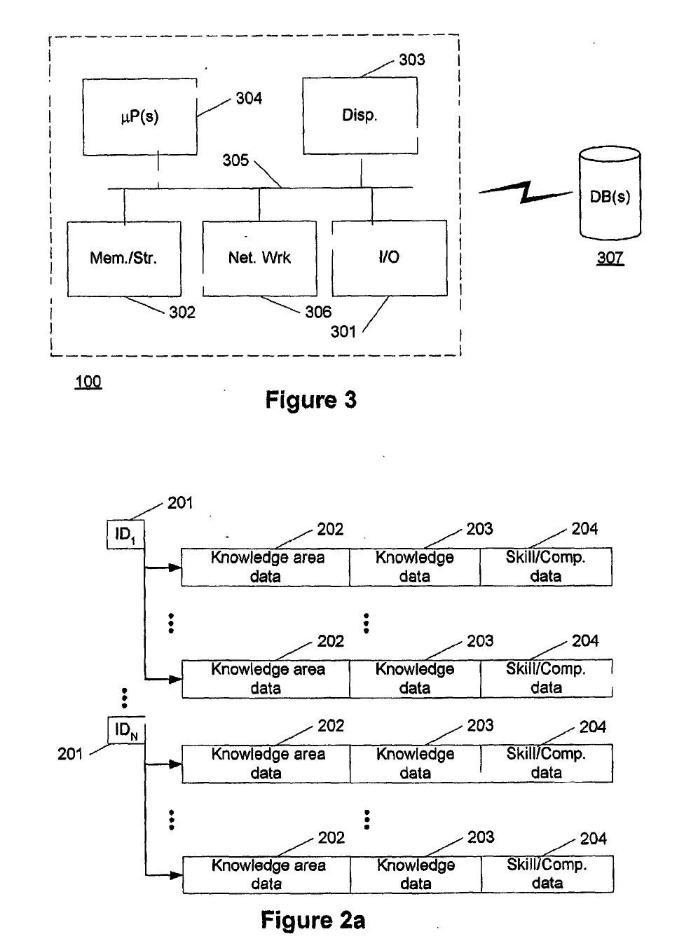

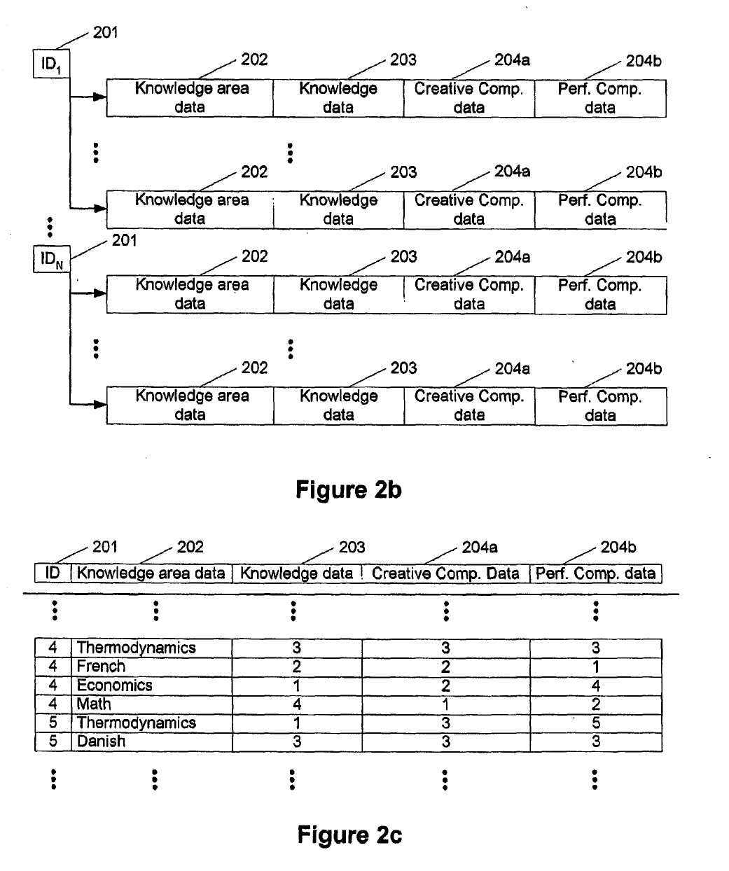

This figure is only meant as an illustration. Preferably, the knowledge profile would be stored in the database as a matrix-structure or as two vector-structures, array structures, etc., containing numbers representing the level and numbers representing the knowledge area, as e.g. explained in greater detail in connections with FIGS. 2a-2c. As a very simple example, (1,3);(3,7) could represent a knowledge level of ‘1’for a knowledge area being represented by the number ‘3’and a knowledge level of ‘3’for a knowledge are being represented by the number ‘7’. The relationship between numbers representing a given knowledge area and the corresponding knowledge area could e.g. be stored as a table in the same or an additional database of the system, e.g. as (3, math) . . . (7, biochemistry), which would cause the above example of (1,3);(3,7) to represent a knowledge profile stating that the given employee has a knowledge level of 1 and 3 in math and biochemistry, respectively.

Alternatively, other database representations of such information are possible which are widely known in the prior art.

The specific knowledge areas supported/implemented by a system/method according to the present invention may vary from company to company. E.g. there would most likely be a great difference in knowledge areas in a system used in an engineering consulting company operating only locally and a Financial Investor Company operating in many countries with different languages. Additionally, a distinction may be made in the knowledge areas of the system/method, if useful, between public and company specific knowledge. Public knowledge may be the automatic score that refers to the individual educational level, while company specific knowledge may be the individual build experience, which is assessed in the company. More specifically, there is an objectivity related to public knowledge, i.e. same reference in each company, and an assessment by a management in company specific knowledge. This separation/distinction may be useful if e.g. a benchmarking system is needed for two different companies, since these two kinds of different knowledge would have to be marked separately. Additionally, some knowledge may also be termed as ‘Strategic Knowledge’ representing knowledge that has a particularly high relevance to the company, i.e. knowledge needed for core-business and ‘Support Knowledge’ representing helpful knowledge not specifically needed for the core business but supporting the company, structure, etc.

Further, a further distinction may be made with respect of knowledge. Knowledge may e.g. comprise professional knowledge/skills, like thermodynamics, medico, language, geology, linguistic, signal current, etc.), Support Knowledge, like Spanish, English, German, IT, Law, etc., and Additional Knowledge like hunting, football, knowledge of specific countries, travel, etc. The distinctions may e.g. be represented by a value in an additional field or another data structure. Additionally, a distinction may also be made if a given knowledge is a knowledge area or a sub-part of a knowledge area.

FIG. 1c illustrates a knowledge profile for knowledge sub-parts of a given knowledge area. Shown is a graph illustrating various levels (103) of different knowledge parts (105) for a given employee. The knowledge parts (105) are sub-parts (105) of a given knowledge area, i.e. the sub-parts (105) all belong or fall under the same knowledge area. As an example the knowledge area ‘Math’ may comprise knowledge sub-parts like ‘Arithmetic’, ‘Calculus’, ‘Differential Equations’, etc.

In the specific example shown in FIG. 1c, the sub-parts (105) is ‘Literary History’, ‘Comparative Literature History’, ‘Linguistics’, Dialects’, ‘Modern Imaginative Literature’, ‘Poetry’, ‘Medieval Literature’, e.g. belonging to the knowledge area ‘Literature’.

The knowledge sub-parts (105) conveys a more detailed picture of a given knowledge within a particular knowledge area, which may be useful for some embodiments/implementations of the system/method of the present invention.

These levels (103) for each sub-part within a specific knowledge area may also be stored and used in the system/by the method according to the present invention. The sub-part may e.g. be used to derive, calculate, etc., a level for the specific knowledge area that they belong to according to an appropriate function dependent on the specific implementation. As an example, an average or a weighted average may be used to derive the level for the knowledge area. The sub-parts may also be used in addition to knowledge areas to give a more detailed and/or diversified picture of the knowledge area.

Depending on to the specific embodiment of the present invention knowledge sub-parts may or may not be used in the system/by the method of the present invention.

FIG. 1d illustrates a schematic graph-representation of a first part of a competence/skill profile according to the present invention and of a second part of a competence/skill profile according to the present invention.

Shown is graph illustrating a level (103) for a first part of a competence/skill representing a creative competence (CC) profile data and a level (103) for a second part representing a performance competence profile (CP) data of a competence/skill level for a given employee. Shown are a first axis (102) and a second axis (101). The first axis (102) represents the various levels (103) of the performance competence (CP) profile data that represents a measure of the degree of possible activity based on a given knowledge for the given employee. The second axis (101) represents the various levels (103) of the creative competence profile data that represents a measure of what an employee is capable of with a given knowledge.

Each competence is registered in accordance with a taxonomy that preferably clearly separates the level (103) into 5 individual (1-5) levels.

The 5 levels in this particular embodiment for creative competence are

1 represents that an employee is capable, with a given knowledge, of carrying through a dialog superficially and at an agreed time,

2 represents that an employee is capable, with a given knowledge, of reproducing a professional segment and has the ability to understand and interpret the professional segment,

3 represents that an employee is capable, with a given knowledge, of exemplifying and entering the professional segment in relevant contexts and wherein the person has knowledge of complementary professional segments and problems and is able to draw limits relative to profession and level, and/or is single looper (commonly known term from within the field of organizational theory that defines a specific behavior and competence) in a limited number of areas of profession/subjects,

4 represents that an employee is capable, with a given knowledge, of using knowledge parts, estimating, analyzing, relating relative to defined goals and wherein the person is able to schedule the planning on meta-level, associate, orient himself, estimate and argue,

5 represents that an employee is capable, with a given knowledge, of personally estimating context, relations, handling many levels of abstraction, complexities, combine in new ways, inter-relate/combine professions/subjects, methods, systems, and/or wherein the person is a double-looper.

The 5 levels in this particular embodiment for performance competence are:

1 represents that the given employee works most optimally alone in a known environment with known subject-matter,

2 represents that the given employee also works in a team with known subject-matter,

3 represents that the given employee also works both in a team and/or independently with known/unknown subject-matter in a known/unknown environment,

4 represents that the given employee also additionally is able to plan, arrange, engage, enthuse and take responsibility, and

5 represents that the given employee also additionally is able to move globally, win over a large foreign audience in a foreign language and create confidence through media.

The shown example has the value/level 2 for performance competence and 4 for creative competence, signifying that the given employee for the related knowledge area works most optimally alone in a known environment with known subject-matter but also works in a team with known subject-matter (as given by 2 in performance competence), and that an employee is capable, with a given knowledge, of using knowledge parts, estimating, analyzing, relating relative to defined goals and wherein the person is able to schedule the planning on meta-level, associate, orient himself, estimate and argue (as given by 4 in creative competence).

Preferably, one measurement/level of creative competence and one measurement/level is registered and stored for each knowledge area for a given employee.

The graph is for illustrative purposes only. Preferably, only a single number is stored in a database for each type of competence, i.e. only two numbers are stored, as explained in greater detail in connection with FIGS. 2a -2c.

FIG. 2a illustrates a schematic representation of one embodiment of a data structure according to the present invention. Shown is a part of a data structure comprised in a database. The database comprises, in this embodiment, a plurality of identification data fields (201), where each identification data field (201) represents and/or identifies a given employee, e.g. by a text description, a unique number or a combination. For each identification data field (201), i.e. for each employee, the structure comprises at least one knowledge area data field (202) where the knowledge area data field (202) represents a specific knowledge area (like ‘Math’, ‘French’, etc.). Each knowledge area field (202) is associated with knowledge profile data (203) and skill/competence profile data (204). The knowledge profile data (203) represents a measure of a knowledge and/or experience level of the employee represented/identified by the associated/belonging identification data field (201) within the knowledge area as given by the associated/belonging knowledge area data field (202). The skill/competence profile data (204) represents a measure of a competence level of the employee represented/identified by the associated/belonging identification data field (201) within the knowledge area as given by the associated/belonging knowledge area data field (202). Alternatively, the data structure may comprise knowledge data fields (202) used to represent/describe knowledge sub-parts as described in connection with FIG. 1c, either in addition or in combination with knowledge area data fields (202).

The various fields may comprise data/information according to various schemes. As an example, the identification field (201) may contain numbers unique for each employee, a string comprising their initials, title, function, etc., and/or combinations thereof. The data fields (202; 203; 204) may comprise numeric values (e.g. ‘1’, ‘2’, ‘3’, etc.), ratios (like ‘10%’ and ‘75%’), non-integer values (e.g. ‘1.5’, ‘2.7’, etc.) or characters (e.g. ‘A’, ‘B’, etc.) representing the specific level.

Preferably, the knowledge profile data (203) comprises a numeric value within a predetermined range, where the numeric value determines a knowledge and/or experience level of the employee within the specific knowledge area as given by the associated knowledge area data field (202).

In a preferred embodiment, the numeric value is an integer value selected from among the group consisting of ‘1’, ‘2’, ‘3’, ‘4’, ‘5’, where a numeric value of:

‘1’ represents a knowledge level corresponding to high-school level within the associated specific knowledge area

‘2’ represents a knowledge level corresponding to a bachelor degree level within the associated specific knowledge area

‘3’ represents a knowledge level corresponding to a master degree level within the associated specific knowledge area

‘4’ represents a knowledge level corresponding to a Phd degree level within the associated specific knowledge area, and

‘5’ represents a knowledge level corresponding to Professorship within the associated specific knowledge area.

Alternatively, other standard education levels may be used instead or in addition to the above-mentioned ones.

Alternatively, the numeric value may be an integer value and the predetermined range is [1 . . . 5], where an integer value of 1 represents a superfluous knowledge level within the associated specific knowledge area and an integer value of 5 represents a profound/deep knowledge level within the associated specific knowledge area.

The skill/competence data is preferably also represented by selecting an integer from 5 possible levels (1-5) where a value of ‘1’represents the lowest skill/competence and 5 represents the highest possible skill/competence level possible. The levels may be formulating according to various definitions, criteria, etc.

Further, other uses than employees and their knowledge and competence could be used by a structure like the above-mentioned. For example, each ID data field (201) could represent a company and the associated data fields could represents other useful data. As an example, a venture capitalist company could use the system/method according to the present invention to keep track of various companies that it has invested in and/or various companies that represent a potential investment. In this case, the stored information could e.g. represent number of patents, progress of development projects, etc.

In this way, it is possible, to structure and track on immaterial, non-financial development in innovative processes, that typically cannot be estimated on the basis of their financial performance and decide whether a business unit or a start-up company is interesting to invest venture capital into.

FIG. 2b illustrates a schematic representation of an alternative embodiment of a data structure according to the present invention. The data structure corresponds to the one shown in FIG. 2a, with the exception that the skill/competence profile data (204 in FIG. 2a) comprises or is comprised by a first part (204a) comprising creative competence profile data representing represents a measure of what an employee is capable of with a given knowledge and a second part (204b) comprising performance competence profile data that represents a measure of the degree of possible activity based on a given knowledge for the given employee representing an ability of using knowledge, i.e. with respect to communicating, cooperating, and generating knowledge.

Preferably, a scoring for creative competence is done according is divided into five different level where:

1 represents that an employee is capable, with a given knowledge, of carrying through a dialog superficially and at an agreed time,

2 represents that an employee is capable, with a given knowledge, of reproducing a professional segment and has the ability to understand and interpret the professional segment,

3 represents that an employee is capable, with a given knowledge, of exemplifying and entering the professional segment in relevant contexts and wherein the person has knowledge of complementary professional segments and problems and is able to draw limits relative to profession and level, and/or is single looper in a limited number of areas of profession/subjects,

4 represents that an employee is capable, with a given knowledge, of using knowledge parts, estimating, analyzing, relating relative to defined goals and wherein the person is able to schedule the planning on meta-level, associate, orient himself, estimate and argue, and

5 represents that an employee is capable, with a given knowledge, of personally estimating context, relations, handling many levels of abstraction, complexities, combine in new ways, inter-relate/combine professions/subjects, methods, systems, and/or wherein the person is a double-looper.

Preferably, a scoring for performance competence is done according is divided into five different level where:

1 represents that the given employee works most optimally alone in a known environment with known subject-matter,

2 represents that the given employee also works in a team with known subject-matter,

3 represents that the given employee also works both in a team and/or independently with known/unknown subject-matter in a known/unknown environment,

4 represents that the given employee also additionally is able to plan, arrange, engage, enthuse and take responsibility, and

5 represents that the given employee also additionally is able to move globally, win over a large foreign audience in a foreign language and create confidence through media.

This enables a more diversified measurement of intellectual, immaterial, intangible assets in the form of competence according to the present invention.

FIG. 2c illustrates exemplary values in a part of a data structure according to one embodiment of the present invention.

Shown is a header/database keys (corresponding to the structure shown in FIG. 2b) comprising: an ID field (201), a knowledge area field/profile (202), a knowledge data field/profile (203), a creative competence data field/profile (204a) and a performance competence data field/profile (204b).

In this simple example, the part of the structure in the database(s) that is shown in the figure, comprises a number of values stating that: Employee identified by ‘4’ has (3;3;3) in (Knowledge level; Creative Competence; Performance Competence) for the knowledge area ‘Thermodynamics’; has (2;2;1) in French; has (1;2;4) in Economics and has (4;1;2) in Math. Additionally, employee identified by ‘5’has (1;3;5) in Thermodynamics and (3;3;3) in Danish.

Alternatively, instead of a number being used to identify a given employee a string of characters may be used (e.g. comprising the initials, name, title, etc.) of the employee.

FIG. 3 illustrates a schematic block diagram of a system according to the present invention. Shown is system (100) system for enabling measurement and control of immaterial/intellectual/intangible resources comprising comprising one or more microprocessors (304) in communication with at least one database (307), a storage (302), a display unit (303) and input/output means (301) connected via a bus (305). The input/output means (301) is responsible for receiving/communicating input from/to a user and communicating with one or more databases (307) e.g. via a network, like the Internet, a Intranet, etc. Alternatively, the database(s) (307) may also be stored internally of the system (100). The storage (302) comprises relevant user information, the data structure according to the present invention and other relevant software, firmware, etc. The user interacts via the input/output means (301), which is processed by the processor (304) in order to facilitate the advantages of the present invention.

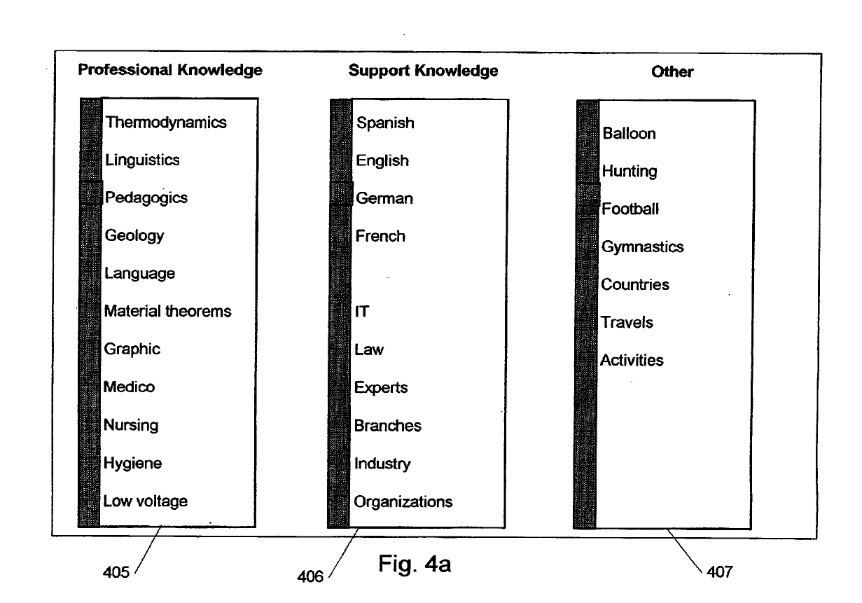

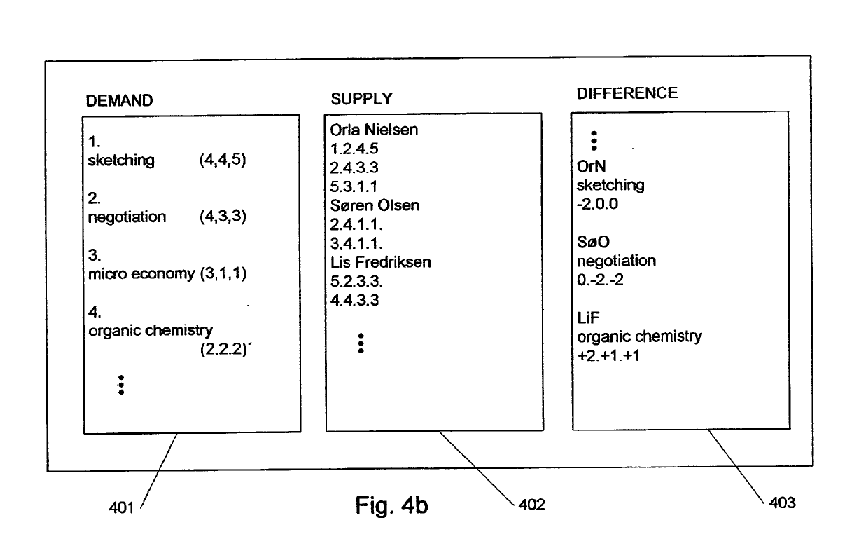

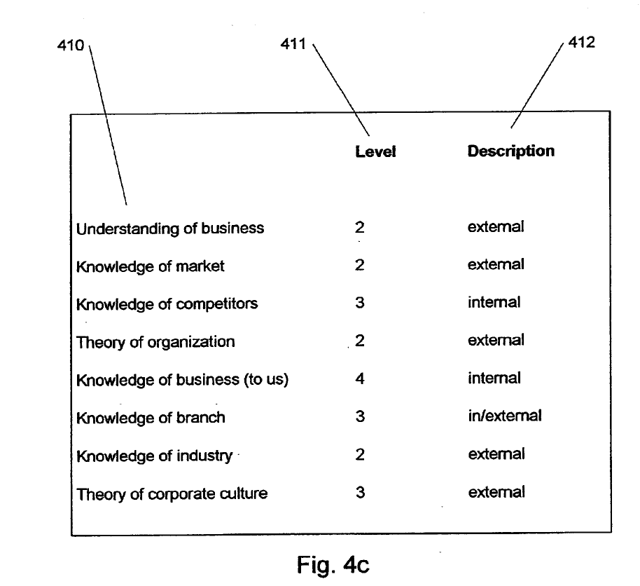

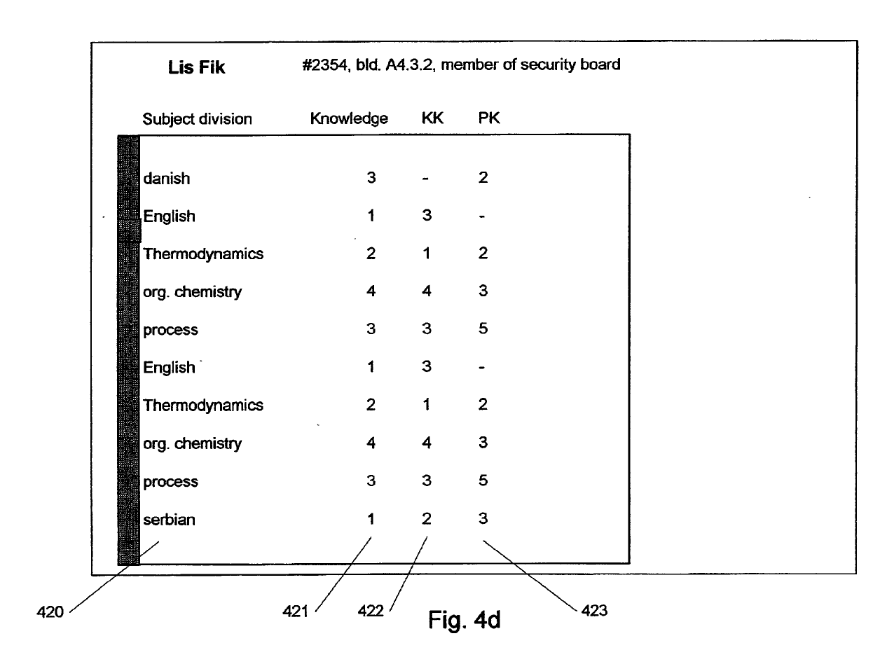

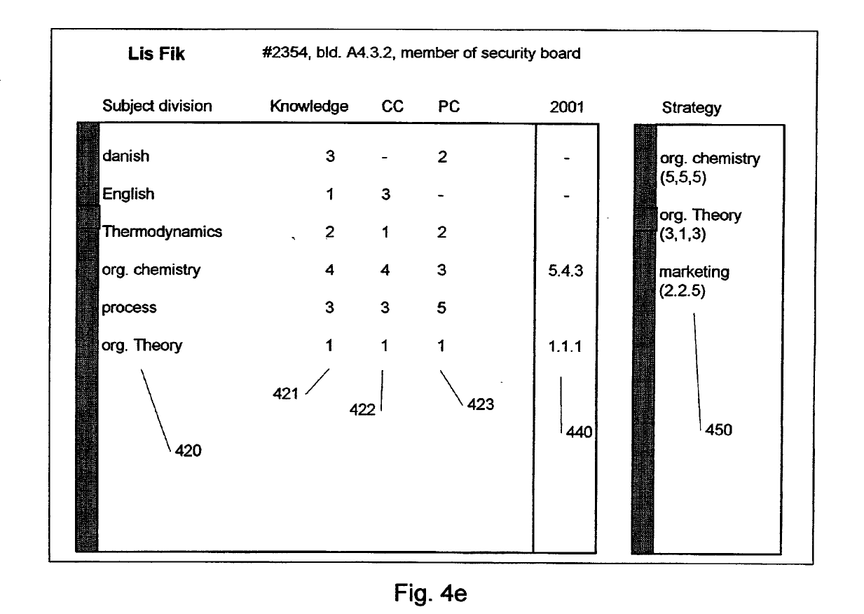

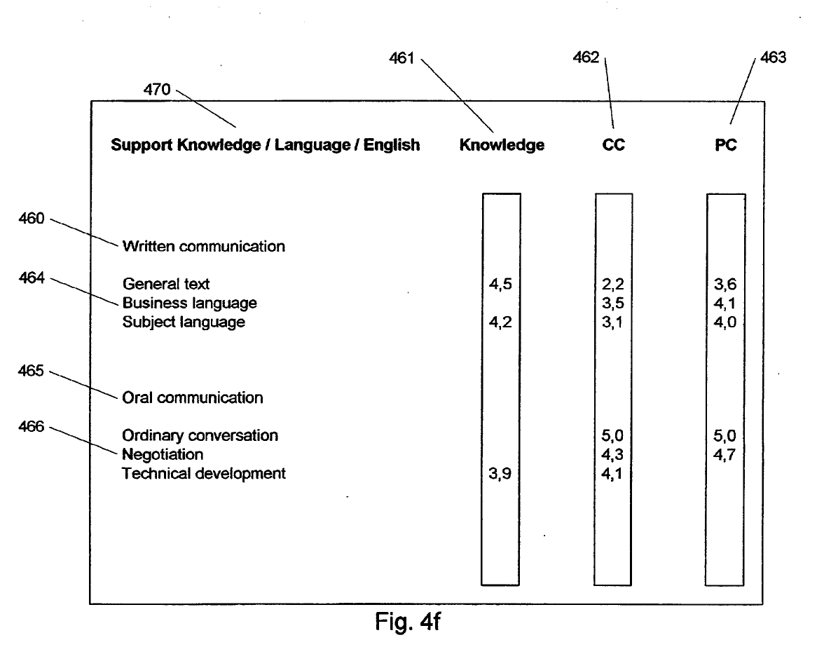

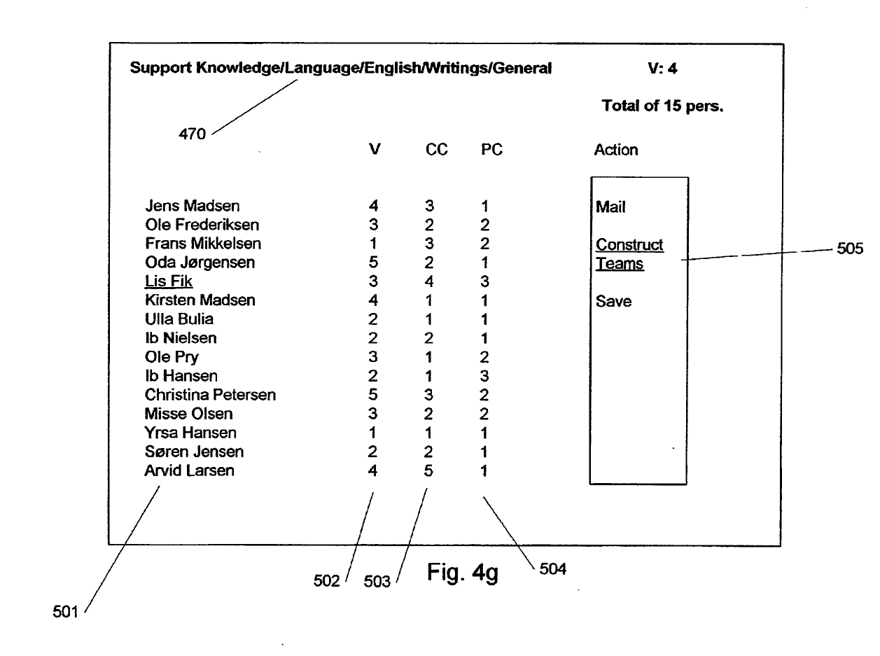

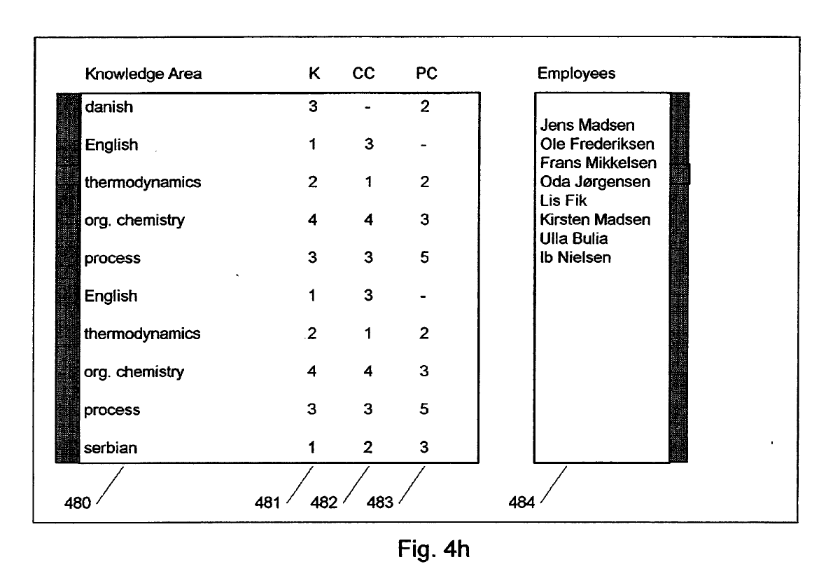

FIG. 4a illustrates a user interface of the system/method comprising an overview of various knowledge areas. In the figure is shown a first user interface part (405) comprising an overview of knowledge items within the category ‘Professional Knowledge/skills’, a second user interface part (406) comprising an overview of knowledge items within the category ‘Support Knowledge’ and a third user interface part (407) comprising an overview of knowledge items within the category ‘Other’.

This user interface allows a user to browse between different knowledge areas arranged according to different categories. By selecting one of the knowledge areas (e.g. Thermodynamics) the user may be presented by another display, screen, user interface, etc., showing specific details and values for the selected knowledge area and additional information (e.g. if the knowledge is Strategic Knowledge, etc.).

FIG. 4b illustrates a user interface of the system/method comprising an overview of demand, supply and difference for immaterial/intangible assets. Shown is a first user interface part (401) listing items of demand of specific knowledge areas where the demand for a given knowledge area is expressed according to the present invention, i.e. expressed in numeric values for knowledge, creative competence and performance competence for a number of knowledge areas.

The listed demand items could e.g. represent a demand for a project, task, assignment, development, etc., for a given client/customer, but also an internally formulated task, project, etc., or a demand for the entire company, organization, network, etc. or branches, divisions, departments, etc. thereof.

Listed in the first user interface part (401) is a first (1.) demand/requirement for sketching with a level (4,4,5) for (knowledge, creative competence, performance competence) within the knowledge area ‘Sketching’.

Additionally, further demands/requirements are shown (the list may be longer than what is presented within the first user interface part (401) at a time and comprises e.g. standard scroll means, etc.), namely 2.: negotiation with (4,3,3) demand/requirement, 3.: Micro economy (3,1,1) and 4.: organic chemistry (2,2,2) etc.

Additionally, a second user interface part (402) is shown comprising the supply of knowledge within the company, organization, network, etc., meeting (fully or in part) the requirements listed in the first Ul-part (401). Information regarding a number of persons are shown in this part (402) where each person is identified (e.g. by name) and each person has knowledge, experience and/or competence in at least one of the demanded/requested knowledge areas. The persons is determined by querying/searching the database, as explained in greater detail elsewhere. Also shown for each person in the part (402) is a representation of the demanded/requested knowledge area that they have knowledge of and competence for and to what extent, i.e. which values/levels of knowledge and competence do employees have for the demanded/requested knowledge area.

In this example, it may be seen that a person ‘Orla Nielsen’has knowledge and competence within the knowledge area of sketching to the following extent: a level 2 in knowledge/experience, level 4 in creative competence and level 5 in performance competence. This is represented by:

1.2.4.5 being a value for (demanded/requested knowledge field;

knowledge/experience; creative competence; performance competence).

It may also be seen that ‘Orla Nielsen’has (4,3,3) in negotiation and (3,1,1) in a knowledge area not shown in the first Ul-part (401) as indicated by the first ‘5’.

Additionally, other persons matching the requirements/demands fully or in part are shown.

A third user interface part (403) is also shown that comprises differences between items in the demand list (401) and items in the supply list (402). The difference may be shown in various ways. Shown is the difference between the demand for sketching for the person ‘Orla Nielsen’(having the initials OrN) where the difference is listed as ‘−2,0,0’indicating that Orla Nielsen lacks 2 units, level points, etc., of Knowledge in meeting the demand of Knowledge, meets the demand exactly for Creative Competence (as indicated by the second number in ‘−2,0,0’) and also meets the demand exactly for Performance Competence (as indicated by the last ‘0’) for sketching.

Also shown in the difference list (403) is that the person Søren Olsen (initials SøO) lacks two levels of both Creative Competence and Performance Competence in meeting the demand for Negotiation but has a sufficient Knowledge area. It can also be seen that the person Lis Frederiksen (initials LiF) exceeds the demand for Organic Chemistry by 2,1,1 as indicated by ‘+2,+1,+1 ’.

The information in the difference list (403) may be shown in various formats, styles, etc. For example, only the person best matching the demand may be listed for that particular knowledge area. Additionally, every person having any level (other than 0) in either all or, alternatively, at least one of Knowledge, Creative Competence and Performance Competence for the particular knowledge area may be shown. Additionally, a given person may be shown listing how well the values for the given person meet the demand for all the specified knowledge areas and so on. Preferably, only one single person most adequately meeting the demand is shown.

Hereby, it is extremely easy to identify whether the company has manpower with sufficient skills for meeting the demanded task/project. Additionally, a suitable person/team may in this way be chosen/listed/identified for a given task while ensuring that the necessary requirements are fulfilled and overkill is avoided. Additionally, lacking knowledge and competence may also be identified showing a need for recruitment, education, etc.

The supply to a given demand (and thereby the difference between them) may be obtained by receiving the demand knowledge areas and their values and searching in the database for people having any values within the knowledge areas and retrieving and presenting them. The difference calculation is preferably performed straightforwardly by subtraction. Alternatively, a difference score may be performed using weights (i.e. a knowledge difference being more important than performance competence difference) non-linear relationships, and so on.

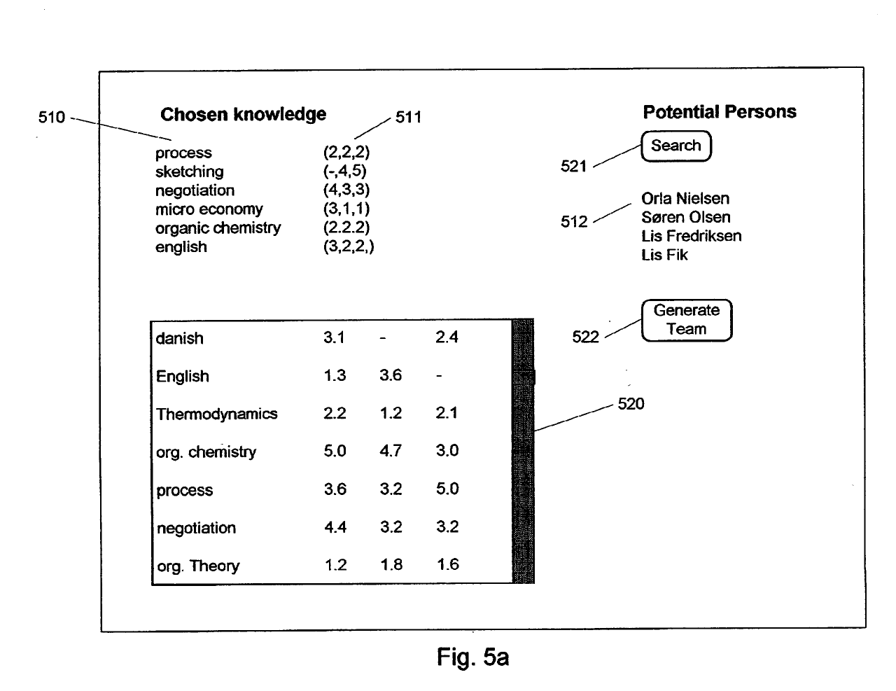

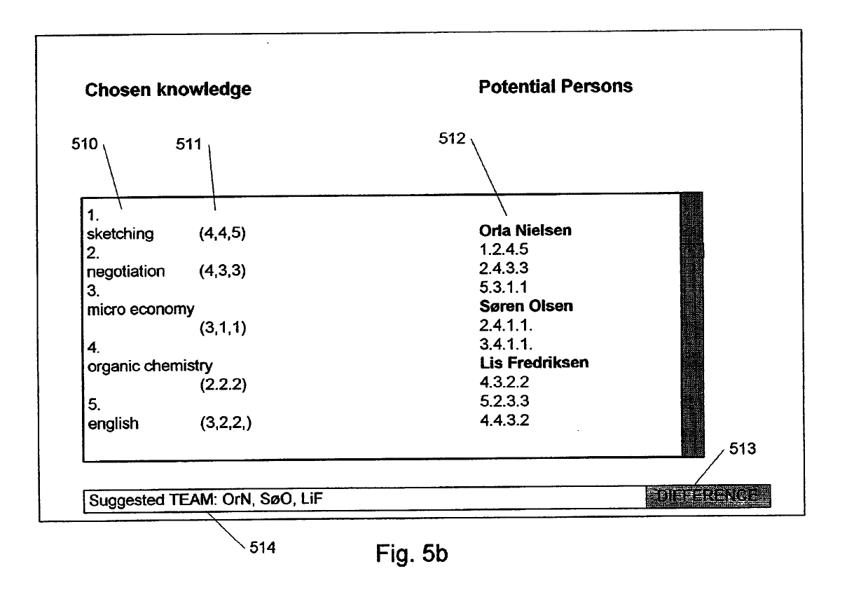

The user interface shown in FIG. 4b may e.g. be presented to a user of the system/method after initiating a search of how well equipped and suited the company is to solve a given task, assignment, etc., or to determine what assets/knowledge, etc. are needed to meet a future demand. Additionally, the user interface in FIG. 4b may be used as part in an automatic team generation process as explained in connection with FIGS. 5a -5b.

FIG. 4c illustrates a user interface that may be used in connection with presentation or identification of strategic knowledge. Shown is a first presentation/Ul-part (410) that lists a number of Knowledge areas being determined (e.g. by management) to be Strategic Knowledge areas, i.e. very important areas, core-business areas or areas of particular interest (e.g. only for a time-period). In a second part (411) a level is given for each Knowledge area in the first part (410). The level represents the level that the management would like an employee to have for the associated Strategic Knowledge Area. A third part (412) list a description e.g. if the Strategic Knowledge is available through internal or external resources. In this way, an employee may readily identify what levels the management desires within a given knowledge area and e.g. use it for planning their own knowledge/competence budget which may be used to stream line education, courses, etc., to best meet the managements wishes.

FIG. 4d illustrates a user/presentation interface used to give an overview of knowledge areas and associated knowledge and competence levels for a given person. Shown is a name of an employee and some identification information. The user interface/presentation interface further comprises a first part (420) listing a number of knowledge areas, e.g. including sub-parts thereof, if applicable, that the selected person has any levels in. Additionally, the specific values of Knowledge (421), Creative Competence (KK) (422) and Performance Competence (PK) (423) are shown for the listed knowledge areas. In this way, it is very easy to obtain an overview of the particular knowledge areas, knowledge/experience, competence/skill, etc., that a given person has.

FIG. 4e illustrates a user/presentation interface the information of the interface shown in FIG. 4d and additional information. The shown interface comprises a knowledge area list (420) that the selected person has any levels in. Additionally, the specific values of Knowledge (421), Creative Competence (CC) (422) and Performance Competence (PC) (423) are also shown for the listed knowledge areas. Additionally, the interface comprises a budget part (440) that shows the given person's individual budget with respect to Knowledge, Creative Competence and Performance Competence. In this example, it may be seen that the person Lis Fik has already fulfilled her budget with respect to Organization Theory but still needs to fulfill the budget for Organic Chemistry by 1 Knowledge level/point.

Also shown is a part (450) that lists the current Strategic Knowledge Areas and their values, so that the person may see how close he/she is at meeting the strategic levels of the strategic knowledge. The shown ‘Strategic Knowledge’ areas are preferably only the ones that are applicable/relevant to the selected person.

FIG. 4f illustrates a user interface useful for finding a person possessing given knowledge. This interface is e.g. used in the process of locating a person having sufficient skills. Also shown are aggregated or total values for the knowledge areas (464, 466) shown to the left.

The interface may be used as a point-and-click search interface used for locating a given resource/person possessing knowledge within a certain knowledge area. Shown are a first knowledge (sub-)category (460) ‘Written Communication’ and a second (sub-)category (465) ‘Oral Communication’ belong to the same (super-)category ‘English’ in a given knowledge structure, taxonomy, etc. The present level in the structure is shown in the tree-structure (470) ‘Support Knowledge/Language/English’ indicating that the user may have point-and-click'ed on items ‘Support Knowledge’, ‘Language’ and then ‘English’ in previous screens before arriving at the present screen (or alternatively jumped directly to this place in the structure e.g. by searching or using a short-cut, etc. In order to proceed, the user may select any of the (sub-)sub-items (464 or 466) to the (sub-)items (460 and 465). The category ‘Written communication’ has the sub-items ‘General Text’, ‘Business Language’ and ‘subject language’ and is itself a sub-item of ‘English’. The category ‘Oral communication’ has the sub-items ‘Ordinary conversation’, ‘Negotiation’ and ‘Technical development’ and is also a sub-item of ‘English’. By selecting a knowledge area in a certain way, the user may be presented by the person(s) that has/have knowledge and/or competence within this particular knowledge area. In this way, it is very easy to locate a person or persons having certain knowledge on a given subject.

Also shown is a total or aggregated Knowledge level (461), a total or aggregated Creative Competence level (462) and a total or aggregated Performance Competence level (463) for the listed areas (464, 466). By total or aggregated level is meant a measure of the level for the whole department, company, organization, etc. Preferably, these aggregated levels are non-integers and are derived on the basis on the individual levels for the employees e.g. as a simple average, a weighted average or as a non-linear function, etc. In this way, it is very easy to obtain information of a current situation with respect to the three levels (461, 462, 463) for each knowledge area.

Alternatively, a keyword search may be used instead or as an alternative to this way of locating people.

FIG. 4g illustrates a user interface at a deeper level in category structure/taxonomy also explained in connection with FIG. 4f. The current level in the knowledge structure/taxonomy is shown in the tree-structure (470) ‘Support Knowledge/Language/English/Writings/General’ indicating that the user is two levels deeper in the knowledge structure/taxonomy than shown in FIG. 4f. Shown is a list (501) of a number of employees and their Knowledge (502), Creative Competence (503) and Performance Competence (504) levels within the knowledge area ‘General English Writtings’ as indicated by (470). Also shown are a number of available choices, actions, etc. One action is ‘Construct Teams’(505) used for automatic team generation as will be explained in connection with FIGS. 5a-5b.

Various levels for competence may initially be determined using a (preferably knowledge area specific) questionnaire that a user has to fill in after which the system/method of the present invention determines the appropriate level. The questionnaire may be part of the system and may initially be presented and taken when online, logged-on, etc.

FIG. 4h illustrates a user interface showing a listing of aggregated/total knowledge and competence for a number of knowledge areas and names of employees who posses this capital. Shown is a first user interface part (480) comprising a scrollable list of knowledge areas. For each knowledge area (480) their aggregated/total values/levels for knowledge (481), creative competence (482) and performance competence (483) is shown. The aggregated levels are preferably derived, as explained elsewhere, by deriving an average or weighted average of the individual levels.

Also shown is, a further user interface part comprising a list of persons (484) having knowledge and/or competence in a particular selected knowledge area. In this way, it is easy to determine what knowledge and/or competence is present in the company, organization, network, etc. and by what production means (e.g. employees, branches, companies of a holding company, portfolio companies, etc.).

FIG. 5a illustrates a user interface of automatic team generation according to the present invention where required knowledge is selected and potential persons may be determined. Shown is a user interface part (510) that lists the chosen knowledge area(s) preferably possessed by the automatic generated team, i.e. which knowledge area(s) is/are required. Also shown is a user interface part (511) specifying for each required knowledge area what (minimum) level should be present in the team. The user adds required knowledge and appropriate levels that have to be met. Additionally, a list of potential persons (512) and a search button (521) to find the potential persons are shown. Preferably, the user may also specify ‘don't cares’, wildcards, etc. The user may e.g. manually choose the potential persons to a team. The potential persons (512) is retrieved from a database by searching for employees having any score/level in the required knowledge area(s), i.e. values in the associated data like a value for knowledge level, a value for creative competence and/or a value for performance competence. In one embodiment, the employees best matching the requirements is presented for each knowledge area, or alternatively a given predetermined number of employees for each knowledge area.

Also shown is a ‘Generate Team’ button (522) for initiating the automatic team generation. After the user has specified all the required knowledge areas (510) and levels (511) the user selects the generate team button (522) and is presented with a result after the team has been generated like the one shown in FIG. 5b.

Further a list (520) is shown, indicating a ‘window’ to the company's knowledge and competence bank/database comprising all the employees registered knowledge and competence(s). The bank/database is preferably structured in a tree-like structure with sub-parts for each knowledge area and so on. By selecting knowledge area in this list (520) different knowledge areas are added to the required/chosen knowledge list (510) and the user may be prompted to input required (minimum) scores for each level (of knowledge, creative competence and performance competence). Hereafter the automated function to set a team will propose adequate persons for this knowledge list.

FIG. 5b illustrates another user interface of automatic team generation where the generated team is presented. Shown is a list of the required knowledge areas (510) and required levels (511) of knowledge, creative competence and performance competence. Also shown is a list (512) of a number of potential persons having at least one or more levels for knowledge, creative and/or performance competence in the required knowledge area.

The suggested team is shown at (514).

Additionally, a ‘Difference’ button (513) is shown. Selecting this would display a screen indicating what the difference is between the team and the required knowledge areas and the required level in knowledge, creative competence and performance competence e.g. like in FIG. 4b.

The suggested team is preferably derived by searching the database for persons having a knowledge area equal to a requested one and selecting the person having the best match of levels to the required levels.

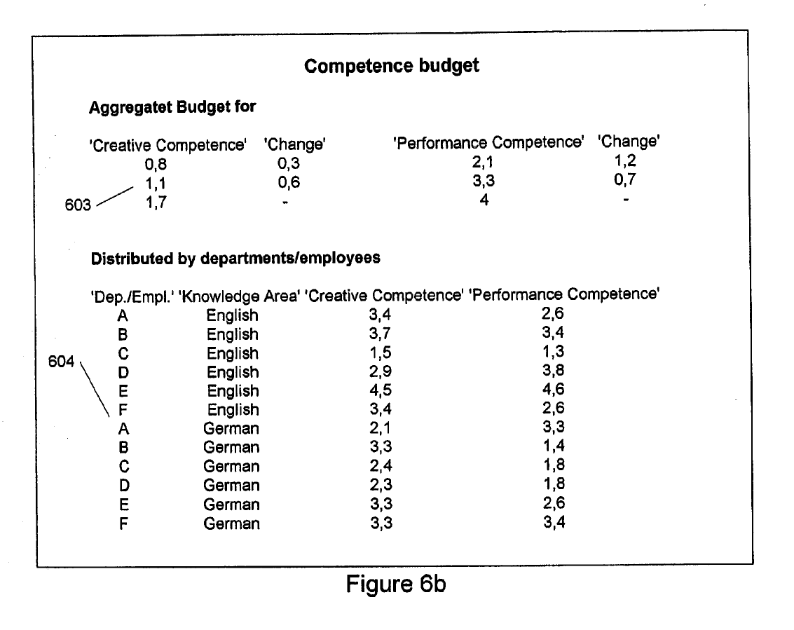

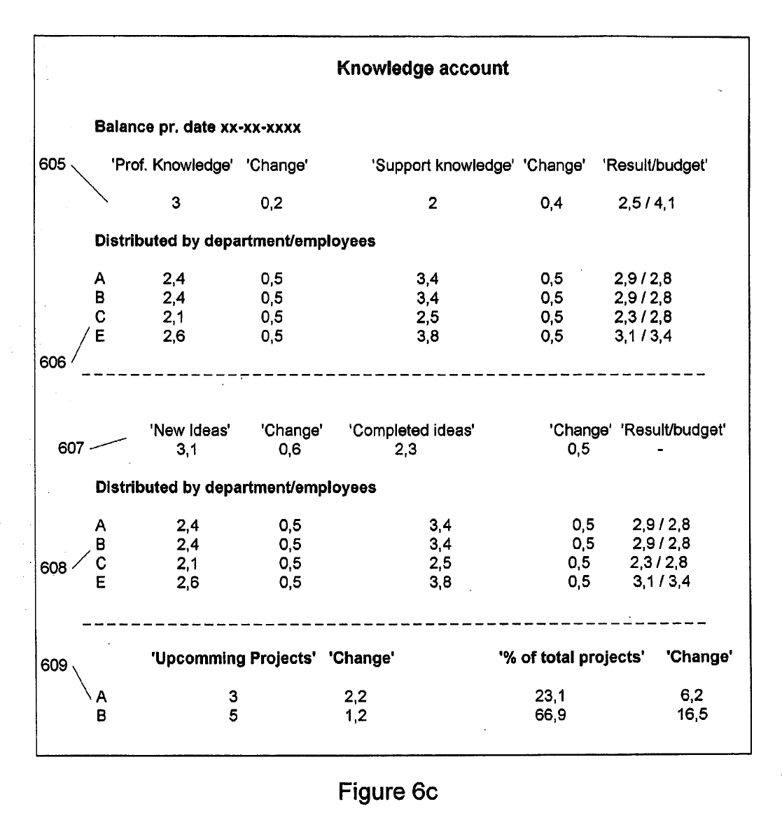

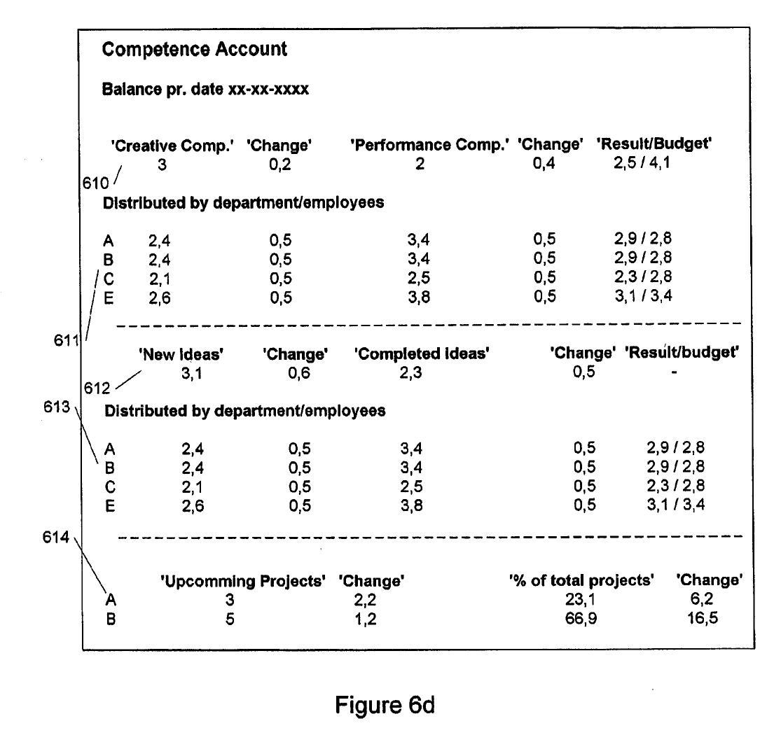

FIG. 6a illustrates a knowledge budget according an embodiment of to the present invention. Shown is a knowledge budget comprising an aggregated budget part (601) that shows aggregated levels/scores/values for ‘Professional Knowledge’, a change of the aggregated levels/scores/values from the present to a prior point in time (e.g. last quarter, last year, etc.). Aggregated levels/scores/values is also shown for ‘Support Knowledge’ as well as a change for these. This information (the key figures) may e.g. be used to visualize a measurable planned goal, development, etc. of knowledge within the organization, company, etc. Later, by measuring the specific intangible assets according to the present invention it is possible to see if the planned goal(s), development, etc. is met. The aggregated budget values, scores, levels, etc., preferably represent the average expected value derived for the workforce, the company, the organization, the holding company, etc., as a whole. Shown in this particular example, is three scores for each of the above key figures. The number of scores being presented is definable and may e.g. only comprise the scores for core-competences. Alternatively, a score may be showed for each or some of the knowledge area in the database.

Also shown is an overview (602) where the knowledge budget is showed for each department, employee, company, etc., and each knowledge area that these possess, which may be used to identify particular valuable departments, employees, companies, etc.

FIG. 6b illustrates a competence budget according an embodiment of to the present invention. Shown is a competence budget that corresponds to the Knowledge budget in FIG. 6a, but where the budget is for the immaterial asset competence instead of the immaterial asset knowledge. The competence budget has a first part (603) comprising aggregated levels/scores/values for ‘Creative Competence’, a change of the aggregated levels/scores/values from the present to a prior point in time (e.g. last quarter, last year, etc.). Aggregated levels/scores/values is also shown for ‘Performance Competence’ as well as a change for these. This information (the immaterial key figures) may e.g. be used for the same purpose as described in connection with FIG. 6a.

An overview (604) of where the knowledge budget is showed for each department, employee, company, etc., which may be used to identify particular budget for each entity (like departments, employees, companies, etc.).

FIG. 6c illustrates a knowledge account according an embodiment of to the present invention. This knowledge account shows what has actually been achieved or what the present level of knowledge is including the change from a previous point in time.

Shown is an aggregated balance of a given date (605) for, in this particular example, professional knowledge, the change thereof and also for ‘support knowledge and a change thereof. Additionally, the present result is shown in relation to the budget. The aggregated values, scores, levels, etc., are preferably derived, as explained earlier, by calculating an average for the scores, values, levels, etc. of every instance (e.g. employer, company, etc.) in a company, organization, etc. Alternatively, the knowledge account may also comprise similar measurements of ‘Strategic Knowledge’.

This information (the key figures) may e.g. be used to if the planned development of knowledge of the organization, company, etc. has been met and how well or bad. Also how well different types of knowledge (e.g. strategic, support, professional, etc.) have fulfilled the budget.

An overview (606) of where the knowledge account distributed for each department, employee, company, etc., is also shown, which may be used to identify particular valuable, successful, expanding, decreasing, etc. departments, employees, companies, etc.

Also shown is an account (607) of the aggregated number of new ideas, the change thereof, the aggregated/total number of completed ideas, a change thereof and the result in relation to the budget. In this particular example, no budget has been formulated for new ideas and/or the completion of these. Values, scores, levels for this is also shown on department, employee, etc. basis (608).

Additionally, a measurement of upcoming knowledge giving projects, a change thereof, a ratio of upcoming projects compared to total number of projects and a change thereof is also shown (609), which may identify whether fewer or more projects are started (compared to the total number of projects).

FIG. 6d illustrates a competence account according an embodiment of to the present invention. The competence account corresponds to the knowledge account but differs in which scores are measure. The competence account comprises (610) an aggregated intangible measurement of ‘Creative Competence’, a change for this, ‘aggregated intangible measurement of ‘Performance Competence’, a change for this and the result seen in relation to the budget for competence. This information is also shown (611) on a per department or employee basis.

Also shown is an account (612) of the aggregated number of new ideas, the change thereof, the aggregated/total number of completed ideas, a change thereof and the result in relation to the budget. In this particular example, no budget has been formulated for new ideas and/or the completion of these. Values, scores, levels for this is also shown on department, employee, etc. basis (613).

Additionally, a measurement of upcoming competence giving projects, a change thereof, a ratio of upcoming projects compared to total number of projects and a change thereof is also shown (614), which may identify whether fewer or more projects are started (compared to the total number of projects).

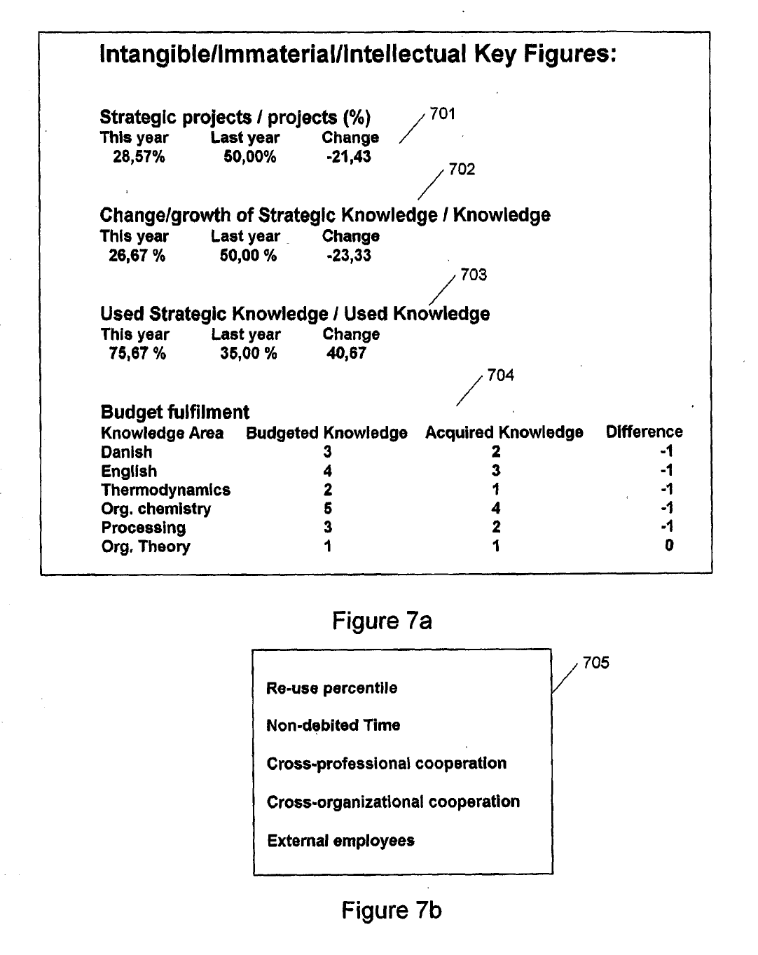

FIG. 7a illustrates intangible/immaterial/intellectual Key Figures and exemplary values according an embodiment of to the present invention. These intangible/immaterial/intellectual Key Figures are preferably used in generation of the accounts according to the present invention. Shown are the following exemplary intangible/immaterial/intellectual key figures and exemplary values.

Strategic projects/projects (%) (701)

| This year | Last year | Change |
|---|---|---|
| 28.57% | 50.00% | −21.43 |

This gives a measure of the development of strategic projects compared to the total number of projects, i.e. signifying how big a part of the ongoing projects are strategic according to management.

Change/growth of Strategic Knowledge/Knowledge (702)

| This year | Last year | Change |
|---|---|---|
| 26.67% | 50.00% | −23.33 |

This gives a measure of the development of strategic knowledge compared to the total amount of knowledge, i.e. signifying how big a part of the knowledge are strategic according to management.

Used Strategic Knowledge/Used Knowledge (703)

| This year | Last year | Change |
|---|---|---|
| 75.67% | 35.00% | 40.67 |

This gives a measure of how much of the used knowledge was strategic knowledge.

Budget fulfilment (704)

Knowledge Area Budgeted Knowledge Acquired Knowledge Difference

Danish 3 2-1

English 4 3-1

Thermodynamics 2 1-1

Org. Chemistry 5 4-1

Processing 3 2-1

Org. Theory 1 1 0

This illustrates how well the budget is fulfilled with respect to intangible, immaterial and intellectual assets.

FIG. 7b illustrates other examples of intangible/immaterial/intellectual Key Figures according to an embodiment of the present invention. Shown are intangible/immaterial/intellectual key figures (705): Re-use percentile, Non-debited Time, Cross-professional cooperation, Cross-organizational cooperation, External employees.

By measurable units for intangible/immaterial/intellectual assets it is possible to plan and control these resource in a department, company, holding company, company portfolio for venture capitalists, etc. in a very simple, efficient and structure manner which may be automated to a very high extent.

1. A system for enabling measurement and control of immaterial/intellectual/intangible resources comprising
a processing unit,
at least one database in communication connection with the processing unit,
wherein said at least one database comprises a data structure for a plurality of employees, said data structure comprising
a plurality of identification data fields, each identification data field representing and identifying a given employee,
at least one knowledge area data field for each identification data field, each knowledge area data field representing a specific knowledge area and being associated with knowledge profile data and skill/competence profile data,
knowledge profile data for each knowledge area data field, the knowledge profile data representing a measure of knowledge and/or experience of an employee represented by said identification data field, and
skill/competence profile data for each knowledge area data field, the skill/competence profile data representing a measure of competence of an employee represented by said identification data field.

2. A system according to claim 1, wherein said knowledge profile data comprises a first type of numeric value within a predetermined range, the first type of numeric value determining a knowledge and/or experience level of an employee, represented by an associated identification data field, within the knowledge area represented by the associated knowledge area data field.

3. A system according to claim 1, wherein said skill/competence profile data comprises a first part comprising a creative competence profile data representing what an employee is capable of with a given knowledge and a second part comprising a performance competence profile data representing the degree of possible activity based on a given knowledge for the given employee.

4. A system according to claim 3, said creative competence profile data comprising a second type of numeric value within a predetermined range, the second type of numeric value determining the level of what an employee is capable of with a given knowledge.

5. A system according to claim 3, wherein said performance competence profile data comprises a third type of numeric value within a predetermined range, the third type of numeric value determining the level of possible activity based on a given knowledge for the given employee.

6. A system according to claim 2, wherein said first type of numeric value is an integer value selected from among the group consisting of 1, 2, 3, 4, 5 and where a numeric value of:
1 represents a knowledge level corresponding to high-school level within the associated specific knowledge area
2 represents a knowledge level corresponding to a bachelor degree level within the associated specific knowledge area
3 represents a knowledge level corresponding to a master degree level within the associated specific knowledge area
4 represents a knowledge level corresponding to a Phd degree level within the associated specific knowledge area, and
5 represents a knowledge level corresponding to Professorship within the associated specific knowledge area.

7. A system according to claim 2, wherein said third type of numeric value is an integer value and said predetermined range is [1 . . . 5] where an integer value of 1 represents a superfluous knowledge level within the associated specific knowledge area and an integer value of 5 represents a profound/deep knowledge level within the associated specific knowledge area.

8. A system according to claim 4, wherein said second type of numeric value is an integer value selected from among the group consisting of 1, 2, 3, 4, 5 and where a numeric value of:
1 represents that an employee is capable, with a given knowledge, of carrying through a dialog superficially and at an agreed time,
2 represents that an employee is capable, with a given knowledge, of reproducing a professional segment and has the ability to understand and interpret the professional segment,
3 represents that an employee is capable, with a given knowledge, of exemplifying and entering the professional segment in relevant contexts and wherein the person has knowledge of complementary professional segments and problems and is able to draw limits relative to profession and level, and/or is single looper in a limited number of areas of profession/subjects,
4 represents that an employee is capable, with a given knowledge, of using knowledge parts, estimating, analyzing, relating relative to defined goals and wherein the person is able to schedule the planning on meta-level, associate, orient himself, estimate and argue, and
5 represents that an employee is capable, with a given knowledge, of personally estimating context, relations, handling many levels of abstraction, complexities, combine in new ways, inter-relate/combine professions/subjects, methods, systems, and/or wherein the person is a double-looper.

9. A system according to claim 5, wherein said third type of numeric value is an integer value selected from among the group consisting of 1, 2, 3, 4, 5 and where a numeric value of:
1 represents that the given employee works most optimally alone in a known environment with known subject-matter,
2 represents that the given employee also works in a team with known subject-matter,
3 represents that the given employee also works both in a team and/or independently with known/unknown subject-matter in a known/unknown environment,
4 represents that the given employee also additionally is able to plan, arrange, engage, enthuse and take responsibility, and
5 represents that the given employee also additionally is able to move globally, win over a large foreign audience in a foreign language and create confidence through media.

10. A System according to claim 1, wherein said system further comprises means for generating a team for a specified project/task/etc., comprising
means for inputting/specifying knowledge and/or competence requirements for at least one knowledge area, and
means for searching in said database for at least one employee having knowledge profile data and/or competence profile data being a best match with the knowledge and/or competence requirements.

11. A system according to claim 10, wherein said system further comprises means for calculating a measure of difference between said at least one matched result and said inputted/specified knowledge and/or competence requirements.

12. A system according to claim 2, wherein said system further comprises means for generating an intangible key figure for a company by
calculating an aggregated knowledge score for a given knowledge area on the basis of a derived average of each of said first type of numeric values representing a knowledge/experience level of an employee, and/or
calculating an aggregated competence score for a given knowledge area on the basis of a derived average of each of said second type and/or said third type of numeric values representing a competence level of an employee.

13. A system for enabling measurement and control of immaterial/intellectual/intangible resources comprising
a processing unit,
at least one database in communication connection with the processing unit,
wherein said at least one database comprises a data structure, said data structure comprising data representing a measurable unit of at least one intangible asset associated with at least one identification data field, the identification data field representing and identifying a given production or business unit, and wherein
said system further comprises means for deriving at least one intangible key figure on the basis of said data structure.

14. A system according to claim 13, wherein said intangible asset represents one or more selected from the group of:
knowledge within a given knowledge area,
competence within a given knowledge area, and/or
an immaterial value.

15. A system according to claim 13, wherein said given production or business unit is selected from the group of:
a specific company in an venture capitalist portfolio,
a specific employee,
a department in a given company, and
a company belonging to a holding company.

16. A method of enabling measurement and control of immaterial/intellectual/intangible resources comprising storing in at least one database a data structure comprising, for a plurality of employees,
a plurality of identification data fields, each identification data field representing and identifying a given employee,
at least one knowledge area data field for each identification data field, each knowledge area data field representing a specific knowledge area and being associated with knowledge profile data and skill/competence profile data,
knowledge profile data for each knowledge area data field, the knowledge profile data representing a measure of knowledge and/or experience of an employee represented by said identification data field, and
skill/competence profile data for each knowledge area data field, the skill/competence profile data representing a measure of competence of an employee represented by said identification data field.

17. A method according to claim 16, wherein said knowledge profile data comprises a first type of numeric value within a predetermined range, the first type of numeric value determining a knowledge and/or experience level of an employee, represented by an associated identification data field, within the knowledge area represented by the associated knowledge area data field.

18. A method according to claim 16, wherein said skill/competence profile data comprises a first part comprising a creative competence profile data representing what an employee is capable of with a given knowledge and a second part comprising a performance competence profile data representing the degree of possible activity based on a given knowledge for the given employee.

19. A method according to claim 18, said creative competence profile data comprising a second type of numeric value within a predetermined range, the second type of numeric value determining the level of what an employee is capable of with a given knowledge.

20. A method according to claim 18, wherein said performance competence profile data comprises a third type of numeric value within a predetermined range, the third type of numeric value determining the level of possible activity based on a given knowledge for the given employee.

21. A method according to claim 17, wherein said first type of numeric value is an integer value selected from among the group consisting of 1, 2, 3, 4, 5 and where a numeric value of:
1 represents a knowledge level corresponding to high-school level within the associated specific knowledge area
2 represents a knowledge level corresponding to a bachelor degree level within the associated specific knowledge area
3 represents a knowledge level corresponding to a master degree level within the associated specific knowledge area
4 represents a knowledge level corresponding to a Phd degree level within the associated specific knowledge area, and
5 represents a knowledge level corresponding to Professorship within the associated specific knowledge area.

22. A method according to claim 17, wherein said third type of numeric value is an integer value and said predetermined range is [1 . . . 5] where an integer value of 1 represents a superfluous knowledge level within the associated specific knowledge area and an integer value of 5 represents a profound/deep knowledge level within the associated specific knowledge area.

23. A method according to claim 19, wherein said second type of numeric value is an integer value selected from among the group consisting of 1, 2, 3, 4, 5 and where a numeric value of:
1 represents that an employee is capable, with a given knowledge, of carrying through a dialog superficially and at an agreed time,
2 represents that an employee is capable, with a given knowledge, of reproducing a professional segment and has the ability to understand and interpret the professional segment,
3 represents that an employee is capable, with a given knowledge, of exemplifying and entering the professional segment in relevant contexts and wherein the person has knowledge of complementary professional segments and problems and is able to draw limits relative to profession and level, and/or is single looper in a limited number of areas of profession/subjects,
4 represents that an employee is capable, with a given knowledge, of using knowledge parts, estimating, analyzing, relating relative to defined goals and wherein the person is able to schedule the planning on meta-level, associate, orient himself, estimate and argue, and
5 represents that an employee is capable, with a given knowledge, of personally estimating context, relations, handling many levels of abstraction, complexities, combine in new ways, inter-relate/combine professions/subjects, methods, systems, and/or wherein the person is a double-looper.

24. A method according to claim 20, wherein said third type of numeric value is an integer value selected from among the group consisting of 1, 2, 3, 4, 5 and where a numeric value of:
1 represents that the given employee works most optimally alone in a known environment with known subject-matter,
2 represents that the given employee also works in a team with known subject-matter,
3 represents that the given employee also works both in a team and/or independently with known/unknown subject-matter in a known/unknown environment,
4 represents that the given employee also additionally is able to plan, arrange, engage, enthuse and take responsibility, and
5 represents that the given employee also additionally is able to move globally, win over a large foreign audience in a foreign language and create confidence through media.

25. A method according to claim 16, wherein said method comprises the step of generating a team for a specified project/task/etc., said step comprising
inputting/specifying knowledge and/or competence requirements for at least one knowledge area, and
searching in said database for at least one employee having knowledge profile data and/or competence profile data being a best match with the knowledge and/or competence requirements.

26. A method according to claim 25, wherein said method further comprises calculating a measure of difference between said at least one matched result and said inputted/specified knowledge and/or competence requirements.

27. A method according to claim 17, wherein said method further comprises generating an intangible key figure for a company by
calculating an aggregated knowledge score for a given knowledge area on the basis of a derived average of each of said first type of numeric values representing a knowledge/experience level of an employee, and/or
calculating an aggregated competence score for a given knowledge area on the basis of a derived average of each of said second type and/or said third type of numeric values representing a competence level of an employee.

28. A method for enabling measurement and control of immaterial/intellectual/intangible resources comprising
a processing unit,
at least one database in communication connection with the processing unit,
wherein said at least one database comprises a data structure, said data structure comprising data representing a measurable unit/level of at least one intangible asset associated with at least one identification data field, the identification data field representing and identifying a given production or business unit, and wherein
said system further comprises deriving at least one intangible key figure on the basis of said data structure.

29. A method according to claim 28, wherein said intangible asset represents one or more selected from the group of:
knowledge within a given knowledge area,
competence within a given knowledge area, and/or
an immaterial value.

30. A method according to claim 28, wherein said given production or business unit is selected from the group of:
a specific company in an venture capitalist portfolio,
a specific employee,
a department in a given company, and
a company belonging to a holding company.

31. A computer readable medium having stored thereon instructions for causing one or more processing units to execute the method according to claim 16.
